(19) United States
(12) Patent Application Publication
(10) Pub. No.: US 2019/0172090 A1
(43) Pub. Date: Jun. 6, 2019

(54) INFORMATION PROCESSING DEVICE, INFORMATION PROCESSING METHOD, PROGRAM, AND STORAGE MEDIUM

(71) Applicant: Rakuten, Inc., Tokyo (JP)

(72) Inventors: Eiji FUKUDA, Tokyo (JP); Brendan Cameron Michael PAULL, Tokyo (JP)

(73) Assignee: Rakuten, Inc., Tokyo (JP)

(21) Appl. No.: 16/325,191

(22) PCT Filed: Aug. 31, 2016
(86) PCT No.: PCT/JP2016/075462

§ 371 Date: Feb. 13, 2019

(51) Int. Cl. G06Q 30/02

(52) U.S. Cl. CPC G06Q 30/0244; G06Q 30/0277

(57) ABSTRACT

Content for distribution to a terminal device is selected in accordance with a distribution condition set to each piece of content. A comparison process between an increased gradient value of a display count and an ideal gradient value of the display count of the content selected for distribution to the terminal device is executed. The increased gradient value of the display count is a gradient value from a start of the distribution until a certain time point before an end of a distribution period. The ideal gradient value of the display count is a gradient value obtained based on a distribution period length and a target display count. The distribution condition is adjusted such that a distribution frequency of the content is varied according to the comparison result.

### TECHNICAL FIELD

The present invention relates to an information processing device, an information processing method, a program, and a storage medium and especially relates to a control technique of a distribution of content such as an advertisement.

### BACKGROUND ART

Display of an advertisement on a web page browsed by users has been generally executed. For example, an information providing website and an e-commerce website post various kinds of advertising content.

It has been desired that the advertisement to be displayed is selected such that advertisement effectiveness can be further enhanced. For example, suitable advertisement distribution according to attributes of the users who browse and advertisement distribution according to behaviors of the users such as searching and a keyword input have been executed.

The following Patent Literature 1 discloses a technique regarding advertisement distribution in consideration of a page view of a website.

### CITATION LIST

### Patent Literature

Patent Literature 1: Japanese Patent No. 5614698

### SUMMARY OF THE INVENTION

### Problems to be Solved by the Invention

Usually, there may be a case where a distribution period and a target display count (so-called impression count) are set in posting an advertisement on a website. For example, an advertiser sets the distribution period and a target impression count (hereinafter, the impression is also referred to as “IMP”) with an advertising agency taking a convenience of business and expected advertising effect into consideration. In this case, a distribution server device is obviously desired to acquire the target IMP count in the period. However, in a distribution following a targeting condition and the like, the number of distributions of each advertising content varies depending on a situation of website access by the users. Therefore, the IMP does not always progress as planned or rapidly increases in a certain period.

The advertisement distribution is desirably distributed so as to reach an appropriate IMP evenly in the set distribution period and consequently reach the target IMP count at the end of the distribution period.

Therefore, an object of the present invention is to provide a technique that increases a possibility of acquiring the above-described desirable state while executing a distribution based on a targeting condition and the like.

### Solutions to the Problems

An information processing device according to the present invention includes a distribution control unit, an increasing trend determining unit, and a distribution condition adjusting unit. The distribution control unit selects content for distribution to a terminal device in accordance with a distribution condition set to each piece of content. The increasing trend determining unit executes a comparison process between an increased gradient value of a display count and an ideal gradient value of the display count of the content selected for distribution to the terminal device by the distribution control unit. The increased gradient value of the display count is a gradient value from a start of the distribution until a certain time point before an end of a distribution period. The ideal gradient value of the display count is a gradient value obtained based on a distribution period length and a target display count. The distribution condition adjusting unit changes the distribution condition such that a distribution frequency of the content is varied according to a comparison result by the increasing trend determining unit.

For example, to select and distribute the advertising content, the distribution condition set to each advertising content is adjusted such that a target display count (impression count) is achieved in the planned constant distribution period. In this case, the adjustment based on the comparison result between the increased gradient value and the ideal gradient value of the display count of the advertising content is executed. The increased gradient value is a value of a gradient when taking a time axis and a display count axis into consideration, that is, a value of a ratio of an increased count of the display count (impression count) to a unit time length.

The following is conceivable in the above-described information processing device. The increasing trend determining unit executes the comparison process at every elapse of a unit period in a period from the start of the distribution until the end of the distribution of the content. The distribution condition adjusting unit relaxes or strengthens a fixed width or a fixed count of the distribution condition according to a result of the comparison process.

That is, the comparison process of the gradients and the adjustment of the distribution condition based on the comparison process are successively executed in the distribution period. The relaxation or strengthening of the fixed width of the distribution condition means, for example, increase or decrease in the fixed width of a value of an appearance ratio and the like under the targeting condition. Additionally, the relaxation or strengthening of the fixed count of the distribution condition means deletion and addition of the fixed count (for example, one) of the condition element. That is, this means the fixed increase or decrease are executed regardless of the difference in the gradients. The appearance ratio is a value indicative of a relative probability of being selected for the distribution between the plurality of pieces of content.

The following is conceivable in the above-described information processing device. The distribution condition adjusting unit relaxes or strengthens a variable width or a variable count of the distribution condition according to a difference between the increased gradient value and the ideal gradient value obtained as a result of the comparison process.

That is, the distribution condition is adjusted according to a degree of a difference between the real increased gradient value and the ideal gradient value. The relaxation or the strengthening of the variable width of the distribution condition means a variation of an increase/decrease width of the value of the appearance ratio and the like according to the difference. The relaxation or the strengthening of the variable count of the distribution condition means, for example, a variation of a count of deletion/addition of the condition elements of the targeting condition according to the difference.

The following is conceivable in the above-described information processing device. The increasing trend determining unit executes the comparison process according to the display count of the content reaching a predetermined stage. The distribution condition adjusting unit relaxes or strengthens the distribution condition using a coefficient when an adjustment is determined as necessary from a result of the comparison process. The coefficient is obtained using the distribution period length and an elapsed period length.

The time of the display count reaching the predetermined stage means that the display count reaches a set stage, for example, when the display count reaches 25%, reaches 50%, and reaches 75% of the target. The comparison process is executed at this stage and when the adjustment is determined as necessary from the comparison result at the time, the adjustment is executed with the coefficient calculated from the distribution period length and the elapsed time until the time point.

The following is conceivable in the above-described information processing device. To each piece of content, at least a targeting condition indicative of an attribute of a distribution destination is set as the distribution condition. The distribution condition adjusting unit relaxes or strengthens the distribution condition by increasing or decreasing a count of the attribute of the distribution destination as the targeting condition set to the content.

The attributes of the distribution destinations are, for example, the attributes of the users of the terminal devices who browse the web page and the attributes of the terminal devices in use. Whether the terminal device becomes the distribution target or not is determined with an AND condition or an OR condition including one or a plurality of attributes. With the AND condition including the attributes, as the number of attributes increases, the distribution opportunity decreases, and as the number of attributes decreases, the distribution opportunity increases. With the OR condition, as the number of attributes increases, the distribution opportunity increases, and as the number of attributes decreases, the distribution opportunity decreases.

The following is conceivable in the above-described information processing device. An appearance ratio indicative of a relative probability of being selected for the distribution between the plurality of pieces of content is set. The distribution condition adjusting unit relaxes or strengthens the distribution condition by changing the appearance ratio set to the content.

For example, the distribution ratios are adjustable by setting the respective appearance ratios to the plurality of pieces of content having the targeting conditions all or a part of which are common. For example, with the two pieces of content, an advertisement A and an advertisement B, having the appearance ratios of 30% and 70%, respectively, when the corresponding targeting conditions are met, the distribution control unit selects and distributes the advertisement A with the probability of 30% and selects and distributes the advertisement B with the probability of 70%.

The following is conceivable in the above-described information processing device. The distribution condition adjusting unit changes the distribution condition for another content such that the distribution frequency of the content as a target for the comparison process is varied.

For example, considering the plurality of pieces of content (pieces of competitive content) having the targeting conditions all or a part of which are common, to adjust a distribution frequency of certain content, a distribution frequency of another competitive content may be changed. That is, relatively adjusting the distribution frequency allows accelerating and decelerating the progress of the display count of the certain content.

The following is conceivable in the above-described information processing device. The distribution control unit acquires information on the terminal device as a distribution destination, and selects the content for distribution to the terminal device using the acquired terminal information.

For example, the content is selected according to, for example, whether the terminal device is a PC (personal computer) such as a so-called stationary PC and a notebook PC or a portable device such as a smart phone. For example, when image sizes of the advertisements have different lengths in sizes of lateral widths, the advertisement having the long size is selected for the PC as the terminal device and the advertisement having the short size is selected for the smart phone as the terminal device.

The following is conceivable in the above-described information processing device. The distribution control unit acquires information on a display size in the terminal device as a distribution destination, and t selects the content for distribution to the terminal device using the acquired information on the display size.

Since the web page is displayed by the browser started on the terminal device, its display size depends on a size of a display area assigned to the browser. For example, the most PC users not only display the browser on the entire screen but display the browser on a part of the display screen in some cases. Therefore, an exposed state of the content to the users changes depending on the browser display size at the time point of distribution. Therefore, the suitable content is selected according to the display size.

An information processing method according to the present invention includes: a distribution controlling step of selecting content for distribution to a terminal device in accordance with a distribution condition set to each piece of content; an increasing trend determining step of executing a comparison process between an increased gradient value of a display count and an ideal gradient value of the display count of the content selected for distribution to the terminal device by the distribution controlling step, the increased gradient value of the display count being a gradient value from a start of the distribution until a certain time point before an end of a distribution period, the ideal gradient value of the display count being a gradient value obtained based on a distribution period length and a target display count; and a distribution condition adjusting step of changing the distribution condition such that a distribution frequency of the content is varied according to a comparison result by the increasing trend determining step.

This information processing method allows executing control that achieves the appropriate content distribution by the information processing device.

A program according to the present invention is a program that causes an information processing device to execute functions equivalent to the above-described respective steps. A storage medium according to the present invention stores the above-described program. These program and storage medium achieve the above-described processes by the information processing device.

### Advantageous Effects of the Invention

With the present invention, the distribution of the content such as the advertisement is adjustable such that the target display count (IMP) is easily achieved in the distribution period. Additionally, advertisement distribution is adjustable such that the distribution is executed without a bias of the display count on the time axis in the distribution period.

### BRIEF DESCRIPTION OF THE DRAWINGS

FIG. 1 is a block diagram of a system configuration example of an embodiment of the present invention.

FIG. 2 is a block diagram of a computer device of the embodiment.

FIG. 3 is an explanatory view of a function composition of an advertisement server and a database of the embodiment.

FIG. 4 is an explanatory view of an advertisement table of the embodiment.

FIG. 5 includes explanatory views of types of advertisements of the embodiment.

FIG. 6 is an explanatory view of a result table of the embodiment.

FIG. 7 includes explanatory views of an adjustment process of advertisement distribution of the embodiment.

FIG. 8 is a flowchart of a distributed advertisement selection process example I of the embodiment.

FIG. 9 is a flowchart of a distributed advertisement selection process example II of the embodiment.

FIG. 10 includes explanatory views of display sizes of browsers.

FIG. 11 is a flowchart of a distributed advertisement selection process example III of the embodiment.

FIG. 12 is a flowchart of an adjustment process example I of the embodiment.

FIG. 13 includes explanatory views of the adjustment process example I of the embodiment.

FIG. 14 is a flowchart of an adjustment process example II of the embodiment.

FIG. 15 includes explanatory views of the adjustment process example II of the embodiment.

FIG. 16 is a flowchart of an adjustment process example III of the embodiment.

FIG. 17 is an explanatory view of the adjustment process example III of the embodiment.

### DESCRIPTION OF PREFERRED EMBODIMENTS

The following describes an embodiment in the order listed below.

### <1. System Configuration>

### <2. Process Functions of Advertisement Server and Advertisement Database>

<3. Outline of Adjustment Process of Advertisement distribution>

### <4. Distributed Advertisement Selection Process Example I>

### <5. Distributed Advertisement Selection Process Example II>

### <6. Distributed Advertisement Selection Process Example III>

### <7. Adjustment Process Example I>

### <8. Adjustment Process Example II>

### <9. Adjustment Process Example III>

### <10. Summary and Modifications>

### <11. Programs and Storage Mediums>

### 1. System Configuration

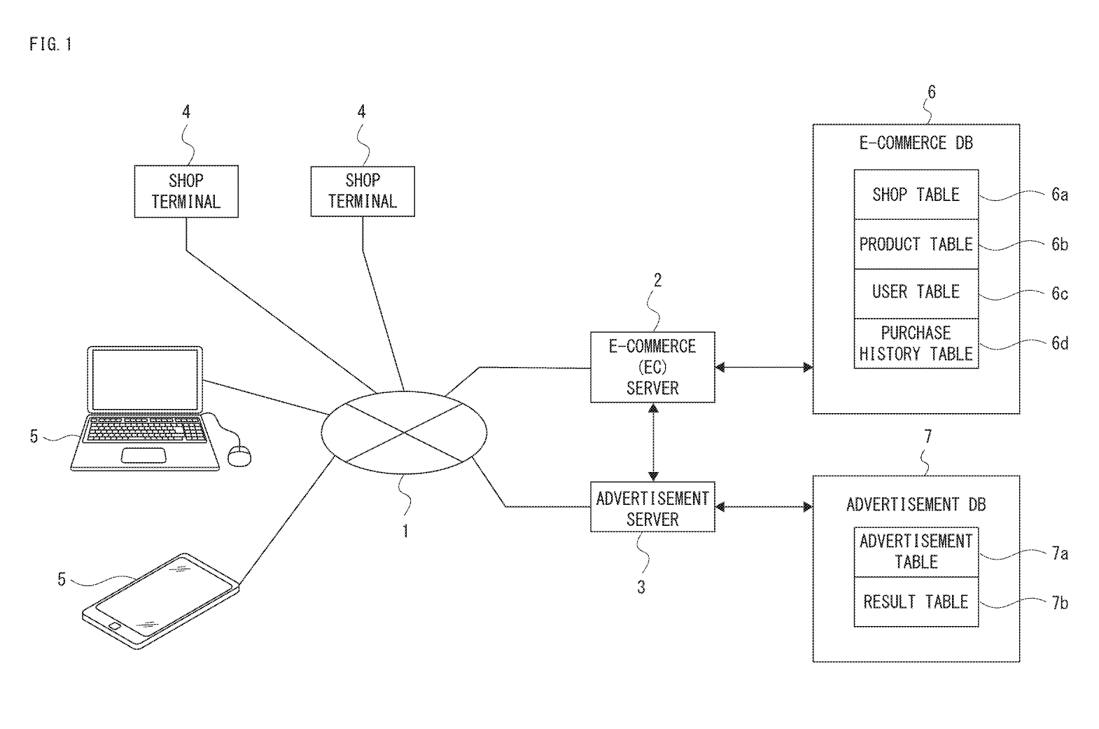

FIG. 1 illustrates a configuration example of a network system that functions as an electronic commerce (EC) system. The EC system achieves a virtual shopping center where a plurality of shops open up. An advertisement server 3 in FIG. 1 is equivalent to an embodiment of an information processing device of the claims of the present invention. The advertisement server 3 of the embodiment is the information processing device that provides advertising content posted on a website distributed by an e-commerce server 2 to users.

As illustrated in FIG. 1, in the EC system according to the embodiment, the e-commerce server 2 (hereinafter referred to as “EC server 2”), the advertisement server 3, a plurality of shop terminals 4, and a plurality of user terminals 5 are mutually communicatively coupled with a network 1.

The EC server 2 is accessible to an e-commerce database 6, and the advertisement server 3 is accessible to an advertisement database 7.

The following describes a database as “DB,” the e-commerce database 6 as “e-commerce DB 6,” and the advertisement database 7 as “advertisement DB 7.”

Various examples are assumed as the configuration of the network 1. For example, the Internet, an intranet, an extranet, a Local Area Network (LAN), a Community Antenna TeleVision (CATV) communications network, a Virtual Private Network, a telephone line network, a mobile communications network, and a satellite communications network are assumed.

Various examples are also assumed as a transmission medium that constitutes all or a part of the network 1. For example, a wired connection such as the Institute of Electrical and Electronics Engineers (IEEE) 1394, a Universal Serial Bus (USB), a power-line carrier, and a telephone line, and a wireless such as an infrared like the Infrared Data Association (IrDA), the Bluetooth (registered trademark), the 802.11 wireless, a mobile phone network, a satellite channel, and a digital terrestrial network are applicable.

The EC server 2 is, for example, a virtual shopping center server functioning as a portal for the virtual shopping center. The EC server 2 executes a process based on a process request received from the shop terminal 4 or the user terminal 5. For example, the EC server 2 provides a search page for a product and a service to the users, provides a shop page to each shop, searches the product and the service according to the search by the users, displays a list of search results, displays advertisements in cooperation with the advertisement server 3, executes a process regarding a product purchase, manages the shops, and manages the users.

The shop terminal 4 is described as an information processing device used by the shop that opens up in the virtual shopping center. The shop terminal 4 is used to, for example, register information on the product sold in the virtual shopping center or similar information with the e-commerce DB 6 via the EC server 2. For example, a dedicated screen provided from the EC server 2 is displayed on a display section of the shop terminal 4. A person responsible of the shop registers the information on the product or similar information with the e-commerce DB 6 via this dedicated screen.

The user terminal 5 is described as an information processing device operated by the user who uses the virtual shopping center to purchase the product and the service. As this user terminal 5, for example, a Personal Computer (PC) having a communication function, a feature phone, a Personal Digital Assistant (PDA), or a smart device such as a smart phone and a tablet terminal is assumed.

The advertisement server 3 cooperate with the EC server 2 and executes various controls to display advertisements on various web pages forming the virtual shopping centers. In the EC system, the web page displayed on the display section of the user terminal 5 includes one or a plurality of advertising areas. Advertising content selected among a plurality of pieces of advertising content is displayed on the advertising area. The advertisement server 3 executes a process such that the respective advertisements achieve desirable display counts as such advertisement display.

In the embodiment, for example, a Hypertext Transfer Protocol (HTTP) daemon is started on the EC server 2. A browser is started on the shop terminal 4 or the user terminal 5, and the shop terminal 4 or the user terminal 5 transmits a process request (HTTP request) to the EC server 2 via the browser. The EC server 2 transmits a process result (HTTP response) corresponding to the above-described process request to the shop terminal 4 or the user terminal 5. For example, the EC server 2 transmits page data described in a web page description language to the shop terminal 4 or the user terminal 5. Based on this page data, the display section of the shop terminal 4 or the user terminal 5 displays a web page screen based on the process result.

The EC server 2 provides the web page as the virtual shopping center to the user terminal 5 by such operation and executes a product search, a product presentation, an advertisement presentation, a settlement process, and similar process according to the request from the user terminal 5. The EC server 2 also executes a provision of a product registration page, a product registration according to the request from the shop terminal 4, and similar process on the shop terminal 4 by the similar operation.

The e-commerce DB 6 stores information necessary for the EC server 2 to execute these processes. The drawing illustrates a shop table 6a, a product table 6b, a user table 6c, and a purchase history table 6d as an example.

With the shop table 6a, data regarding the shops that open up in the virtual shopping center is registered. For example, a shop identification (ID) as a shop identifier, a name, an address, a phone number, and link information (Uniform Resource Locator (URL)) to a web page (shop page) regarding the shop of each shop are registered.

With the product table 6b, data regarding the products treated in the virtual shopping center is registered. For example, with the product table 6b, a product ID as a product identifier, a shop ID of the shop that sells this product, a category of the product, a name, a price, an inventory, and link information (URL) to a web page (product page) regarding the product of each product are registered.

With the user table 6c, data regarding the users who use the virtual shopping center is registered. For example, attribute information such as a user ID, a login password, an address, a name, a sex, and an age, payment information, and an e-mail address of each registered user are registered.

With the purchase history table 6d, data regarding a history of transactions executed in the virtual shopping center is registered. For example, the product ID of the purchased product and information on the product, a purchase shop, date and time of the purchase, and a purchase price of each user ID are registered.

The EC server 2 accesses the e-commerce DB 6 to acquire the information required for the various processes.

The advertisement DB 7 stores information necessary for the advertisement server 3 to execute a control process to display the advertisement. The advertisement DB 7 includes, for example, an advertisement table 7a and a result table 7b.

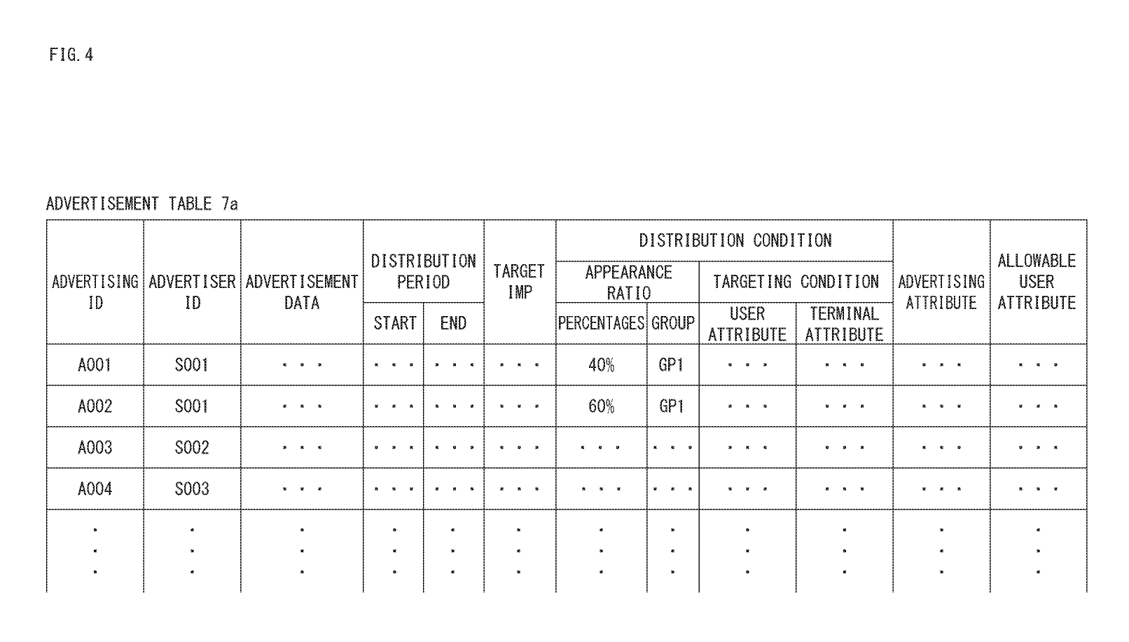

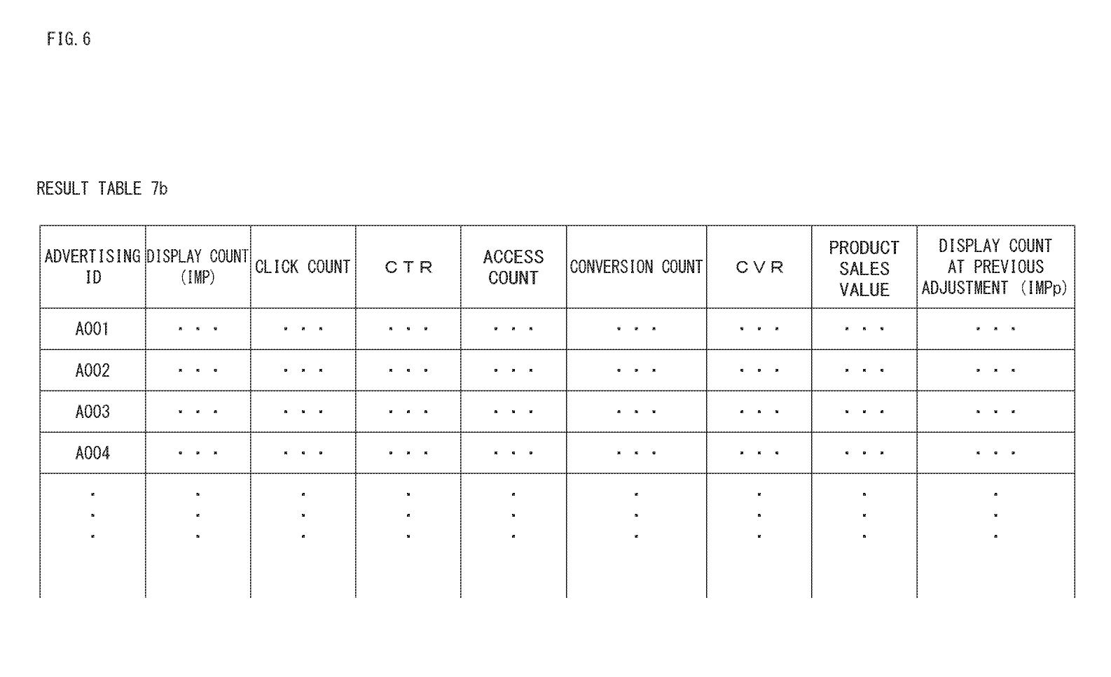

With the advertisement table 7a, information on the advertisements (pieces of advertising content) registered by the shop is registered. With the result table 7b, result data or similar data for evaluation of advertisement effectiveness of each advertisement is registered. Specific data content of each table will be described later in FIG. 4 and FIG. 6.

The advertisement server 3 accesses the advertisement DB 7 to acquire the information necessary for the process to display the advertisement.

As long as the EC server 2 and the advertisement server 3 can execute the access, these e-commerce DB 6 and advertisement DB 7 may be achieved by any configuration. For example, the e-commerce DB 6 may be constructed in a server computer different from the EC server 2 or may be constructed in the EC server 2. Additionally, the advertisement DB 7 may be constructed in a server computer different from the advertisement server 3 or may be constructed in the advertisement server 3.

A part of or all of the e-commerce DB 6 and the advertisement DB 7 may be disposed in, for example, separate computer systems and a computer system at a remote location. Obviously, the respective tables in the e-commerce DB 6 and the advertisement DB 7 need not to be formed in one device (for example, one HDD). Additionally, each DB needs not to be configured as one DB. For example, the information stored as the user table 6c may be stored and managed with a plurality of tables (for example, a user table for login and a user table for transaction).

The examples of the respective DBs and tables merely exemplify a storage unit for the information related to the processes of the embodiment.

The advertisement server 3 and the EC server 2 may be achieved by separate server computers or may be achieved by one server computer.

A provider of an advertising service by the advertisement server 3 and the advertisement DB 7 (that is, an administrator of the advertisement server 3 and the advertisement DB 7) and a provider of the virtual shopping center (that is, an administrator of the EC server 2 and the e-commerce DB 6) may be an identical trader or may be different traders.

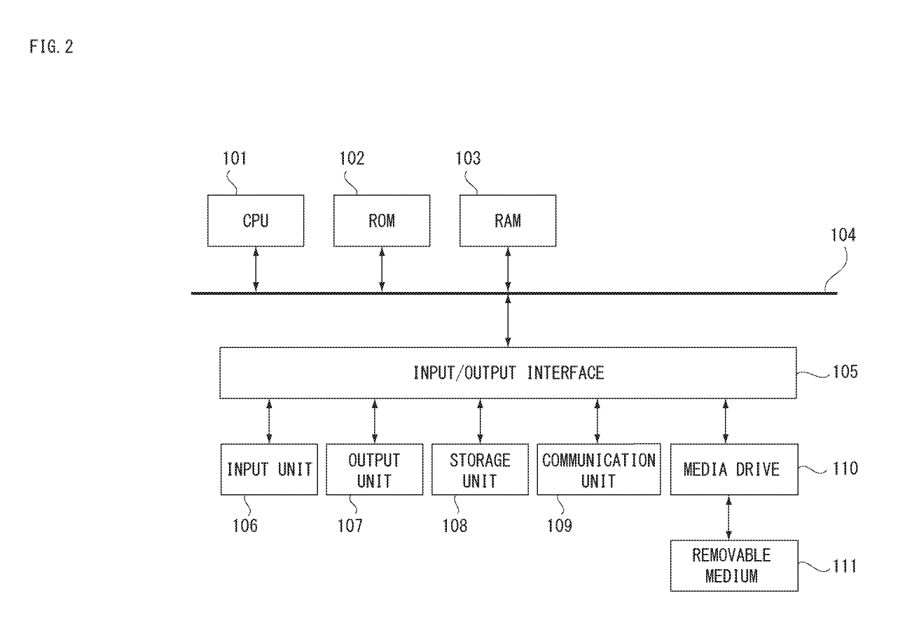

Subsequently, FIG. 2 illustrates a hardware configuration of the information processing device constituting the EC server 2, the advertisement server 3, the shop terminals 4, and the user terminals 5 illustrated in FIG. 1. The respective devices described as the EC server 2, the advertisement server 3, the shop terminals 4, and the user terminals 5 can be achieved as a computer device as illustrated in FIG. 2 that can execute information processing and information communications.

In FIG. 2, a Central Processing Unit (CPU) 101 of the computer device executes various processes in accordance with a program stored in a Read Only Memory (ROM) 102 or a program loaded from a storage unit 108 to a Random Access Memory (RAM) 103. The RAM 103 also appropriately stores data required for the CPU 101 to execute the various processes or similar data.

The CPU 101, the ROM 102, and the RAM 103 are mutually coupled via a bus 104. An input/output interface 105 is also coupled to this bus 104.

To the input/output interface 105, an input unit 106, an output unit 107, the storage unit 108, and a communication unit 109 are coupled.

The input unit 106 includes a keyboard, a computer mouse, a touchscreen, and similar device.

The output unit 107 includes, for example, a display such as a Liquid Crystal Display (LCD), a Cathode Ray Tube (CRT), an organic Electroluminescence (EL) panel, and similar device, and a speaker.

The storage unit 108 is configured of a Hard Disk Drive (HDD), a flash memory device, and similar device.

The communication unit 109 executes a communications process and communications between devices over the network 1.

Additionally, a media drive 110 is coupled to the input/output interface 105 as necessary. A removable medium 111, such as a magnetic disk, an optical disk, a magneto-optical disk, or a semiconductor memory, is appropriately mounted. Thus, information is written to and read from the removable medium 111.

Such computer device uploads and downloads data and a program through communications by the communication unit 109. Such computer device also can exchange the data and the program via the removable medium 111.

When the CPU 101 executes process operations based on various programs, the required information processing and communications as the EC server 2, the advertisement server 3, the shop terminal 4, or the user terminal 5 are executed.

The information processing device constituting the EC server 2, the advertisement server 3, the shop terminal 4, and the user terminal 5 is not limited to be configured of the single computer device as in FIG. 2, and may be configured such that a plurality of computer devices are systemized. The plurality of computer devices may be systemized by the LAN and the like, or may be remotely disposed by the VPN or the like using the Internet or the like. The plurality of computer devices may include an information processing device as a server group (cloud) usable by a cloud computing service.

### 2. Process Functions of Advertisement Server and Advertisement Database

Here, the following describes an operation regarding a search word advertisement and the process functions of the advertisement server 3 for the operation.

The advertiser who desires to advertise make a contract on advertising on a website with a trader who runs the EC server 2 and the advertisement server 3 or a representative of the trader.

The pieces of advertising content of the various advertisers are registered with the advertisement DB 7 and managed such that the advertisement server 3 appropriately displays the pieces of advertising content on the web page.

Usually, an advertising period and an impression (IMP) count (display count) are set in the advertising contract. For example, a period (distribution period) during which certain advertising content is exposed is set as, for example, a period from Jul. 1, 2016 until Jul. 31, 2016 and a target IMP count is set to, for example, 5000000 times.

To achieve the more effective advertisement, a targeting setting is configured to each advertising content. For example, as a target user attribute, a sex, an age group, an address, and the like are set as the targeting conditions. For example, as targeting conditions for an advertisement of a cosmetic product, “from 20 years old to 39 years old” and “female” are set.

The advertisement server 3 executes the process such that the distribution of the advertising content reaching the target IMP count is achieved in the distribution period in accordance with the set targeting conditions.

For example, the advertisement server 3 selects the appropriate advertising content according to the advertisement request from the EC server 2 and transmits the advertising content to the EC server 2. In this respect, the EC server 2 notifies the advertisement server 3 of the user attribute of the user who has executed a web page request. Accordingly, the advertisement server 3 can confirm the targeting conditions, select the appropriate advertising content, and transmit the advertising content. The EC server 2 incorporates the advertising content selected by the advertisement server 3 into an advertising area on the website and distributes the website to the user terminal 5 that has executed the request.

Alternatively, there may be a case where an advertisement request from the user terminal 5 occurs in the advertisement server 3. For example, the EC server 2 transmits the web page including the advertising area to which a program setting of the advertisement request is configured. This web page is displayed by the browser started on the user terminal 5, and the browser interprets a link setting and executes the advertisement request to the advertisement server 3. In this case as well, the advertisement server 3 selects and transmits the appropriate advertising content. As long as the user logs in to the EC server 2, the advertisement server 3 can confirm the user attribute and the like through the EC server 2; therefore, the determination of the targeting condition is also possible.

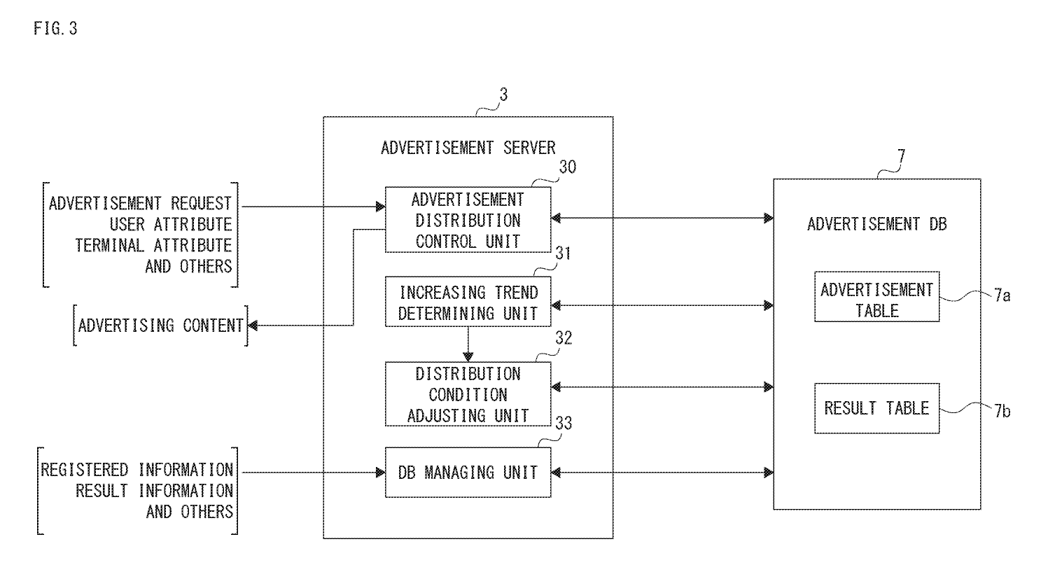

FIG. 3 illustrates a function composition of the advertisement server 3 of the embodiment.

The advertisement server 3 includes an advertisement distribution control unit 30, an increasing trend determining unit 31, a distribution condition adjusting unit 32, and a DB managing unit 33 as the process functions executed by the CPU 101 (see FIG. 2) of the computer device as the advertisement server 3 based on the programs.

All or a part of the processes by these respective functions described hereinafter may be achieved by hardware.

When the respective functions are achieved by software, the respective functions need not to be achieved by the programs independent from one another. One program may execute the processes of the plurality of functions, or one function may be achieved by cooperation of a plurality of program modules.

The respective functions may be decentralized to a plurality of information processing devices. Additionally, one of the functions may be achieved by the plurality of information processing devices.

The DB managing unit 33 executes update management of the respective tables in the advertisement DB 7. The DB managing unit 33, for example, executes a registration process of new advertising content with the advertisement table 7a and deletes advertising content finished to be distributed from the advertisement table 7a.

The DB managing unit 33 executes the update management of the result table 7b according to a reception of result information of each advertising content from, for example, the EC server 2.

The advertisement distribution control unit 30 executes a process of selecting the appropriate advertising content according to the input advertisement request and transmitting the advertising content. That is, the advertisement distribution control unit 30 selects the advertising content to transmit to the user terminal 5 via the EC server 2 or the advertising content to directly transmit to the user terminal 5 from the advertisement server 3 in accordance with the distribution condition and transmits the advertising content to the request source. The distribution condition is, for example, the targeting condition. That is, the advertisement distribution control unit 30 compares the attribute information of the user who uses the user terminal 5 and the targeting conditions set to the respective pieces of content, selects the appropriate advertising content, and transmits the advertising content to the request source.

Accordingly, the advertisement server 3 receives the user attribute together with the advertisement request. In the embodiment, terminal attribute is possibly used especially as the targeting conditions. The terminal attribute is information such as device information (for example, whether the user terminal 5 is a PC, a smart phone, or the like) of the user terminal 5 that requests the web page and information of a window size of the browser displayed on the user terminal 5. The advertisement distribution control unit 30 acquires the terminal attribute at the advertisement request and selects the advertising content according to the terminal attribute.

Further, an appearance ratio is possibly considered as the distribution condition. The appearance ratio is, for example, set to the plurality of pieces of advertising content having the targeting conditions all or a part of which are identical and indicative of a probability that what percentage that the pieces of advertising content are distributed. For example, two pieces of advertising content (an advertisement A and an advertisement B) from an identical advertiser are grouped into one advertisement group having common targeting conditions, and the appearance ratios are set like 70% for the advertisement A and 30% for the advertisement B. In this case, when this advertisement group matches the targeting conditions, the advertisement distribution control unit 30 executes a lottery process that selects the advertisement A with the probability of 70%.

The appearance ratio is not always limited to be set as the relative exposure ratio between the plurality of pieces of grouped advertising content and may be provided as a setting of a probability of the selection of the respective advertisements.

The increasing trend determining unit 31 executes a comparison process between an increased gradient value of the display count from the start of the distribution until a certain time point before the end of the distribution period and an ideal gradient value of the display count obtained based on a distribution period length and the target display count on the advertising content for distribution to the user terminal 5 by the selection by the advertisement distribution control unit 30. This process is executed to adjust the distribution condition.

The distribution condition adjusting unit 32 executes a process that changes the distribution condition such that the distribution frequency of the content is varied according to the comparison result by the increasing trend determining unit 31.

For example, to select and distribute the advertising content, the distribution condition adjusting unit 32 adjusts the distribution condition set to each advertising content such that the target IMP count (display count) is achieved in the planned constant distribution period. In this case, the adjustment based on the comparison result between the increased gradient value and the ideal gradient value of the display count of the advertising content is executed.

The increased gradient value is a value of a gradient when taking a time axis and a display count axis into consideration, that is, a value of a ratio of an increased count of the IMP count to a unit time length.

It is necessary that the advertisement to be distributed is certainly selected following the distribution condition to acquire the meaningful advertisement effectiveness. For example, presenting an advertisement of a product for female students in their teens to a male in one's fifties does not become the meaningful advertisement.

However, when selecting the advertisement following the distribution condition as described above, the advertisement to be selected is determined, depending on the users who execute the access to some extent; therefore, each advertising content does not always reach the target IMP. That is, the administrator of the advertisement server 3 cannot control the IMP count of each advertisement in an arbitrary manner.

Therefore, the embodiment executes the adjustment process such that the target IMP count can be achieved in the distribution period while following the distribution condition.

Further, it is important for the advertisement distribution to, in addition to simply achieving the target IMP count in the distribution period, ensure achieving the appropriate IMP count evenly in the distribution period. For example, in the case where 1000000 impressions in 30 days are targeted, it is not preferred that 500000 impressions are achieved in three days and the remaining 500000 impressions are achieved in the remaining 27 days. This is because that a failure of an appropriate, continuous exposure in the set distribution period lowers the advertisement effectiveness. Therefore, the adjustment process of the embodiment also increases a possibility of the distribution in which the IMP count is not biased in the distribution period.

The following describes examples of pieces of content in respective tables in the advertisement DB 7 accessed by the advertisement server 3 having such functions.

FIG. 4 illustrates one example of the advertisement table 7a. The advertisement table 7a includes respective fields for an advertising ID, an advertiser ID, advertisement data, the distribution period, the target IMP, the distribution condition, the advertising attribute, and an allowable user attribute.

With the advertising ID field, the advertising IDs (A001, A002 . . . ) as identification information uniquely assigned to the respective advertisements are registered.

With the advertiser ID field, IDs (S001, S002 . . . ) of the advertisers who desire to advertise are registered.

With the advertisement data field, data of the pieces of advertising content required to display the advertisements on the display sections of the user terminals 5 are registered. For example, advertisement image data, advertisement text data, and link information (for example, the link information to a shop page or to a product page) are registered as the advertisement data.

With the distribution period field, information on dates and times to start distributions and dates and times to end the distributions set to the advertisements are registered.

With the target IMP field, the target IMP counts set to the advertisements are registered.

With the distribution condition field, the distribution conditions set to the advertisements are registered. The distribution condition in this example is roughly divided into the appearance ratio and the targeting condition.

With the appearance ratio, percentages as the appearance ratios and the advertisement groups to which the appearance ratios are applied are registered. For example, the example in the drawing shows a state where the identical advertisement group GP1 is set to the two pieces of advertising content with the advertising IDs of A001 and A002 and the appearance ratios of 40% and 60% are set, respectively.

The user attribute and the terminal attribute are settable in the targeting condition. As described above, the attribute of the user suitable for presentation is designated in the user attribute. The attribute of the user terminal 5 suitable for presentation is designated in the terminal attribute.

Depending on the adjustment process by the distribution condition adjusting unit 32, a part or all of the above-described distribution conditions are updated.

With advertising attribute field, information on the image sizes and information such as whether the images are still images or moving images are registered as attributes of the pieces of advertising content.

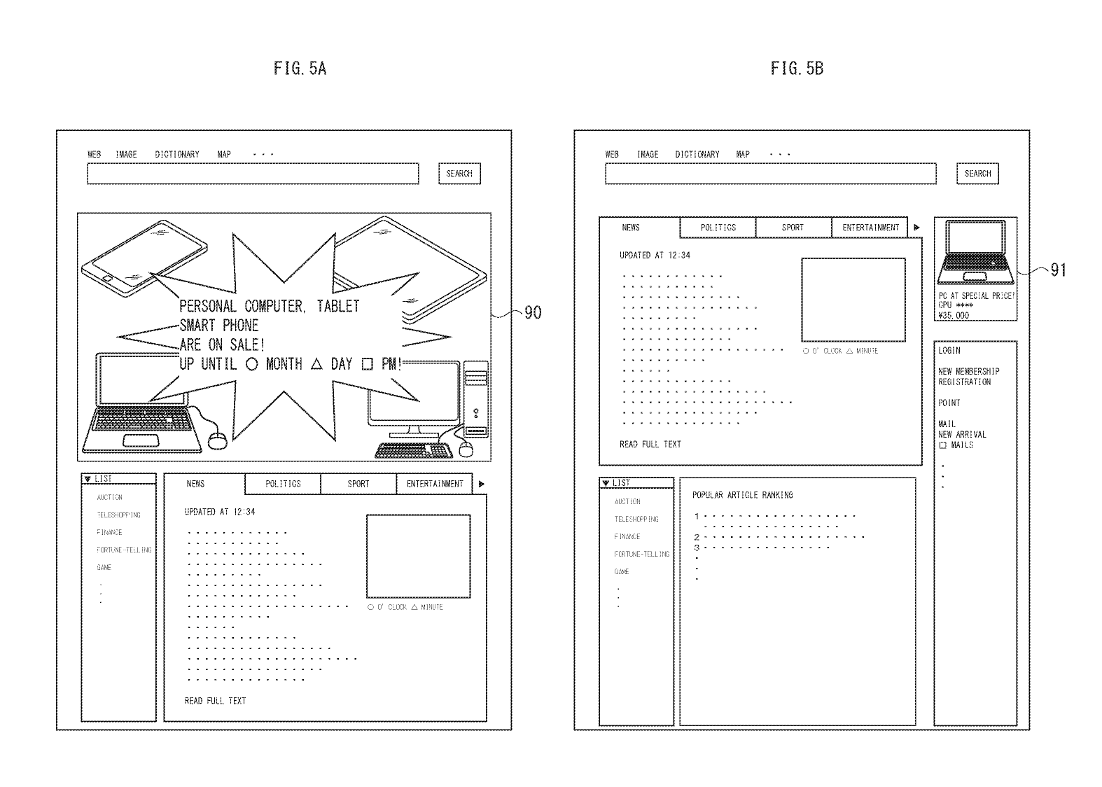

For example, FIG. 5A illustrates a state where a web page displays an advertisement 90 with a large width size. FIG. 5B illustrates a state where the web page displays an advertisement 91 with a comparatively small width size. For example, like these states, the pieces of advertising content having different sizes are present. The large-sized advertisement is especially effective to enhance the advertisement effectiveness.

With the allowable user attribute field, the user attributes settable as the targeting conditions in the distribution conditions are registered. With this field, condition elements that can be added as the targeting conditions, that is, the various attributes of the users allowable as the target when the advertisement effectiveness is considered are registered. For example, the user attributes are the attributes of the users preliminarily selected as the advertisement target by the advertiser.

It is considered that initial user attribute set as the targeting conditions is set, for example, by selecting the condition elements of the allowable user attribute.

This allowable user attribute is registered to ensure changing the targeting condition certainly in the allowable range when the targeting condition is changed.

FIG. 6 illustrates one example of the result table 7b. The result table 7b is a table regarding various index values indicative of the advertisement effectiveness. The result table 7b includes respective fields for the advertising ID, the display count (impression (IMP) count), a click count, a Click Through Rate (CTR), an access count, a conversion count, Conversion Rate (CVR), a product sales value, and a display count at the previous adjustment (IMPp).

The information on the respective lines is associated with the respective advertisements registered with the advertisement table 7a with the advertising IDs (A001, A002 . . . ).

With the display count (IMP count) field, counts (counts of the advertisements being distributed to the user terminals 5) that the display sections of the user terminals 5 display the advertisements are registered.

With the click count field, counts of clicking the advertisements are registered.

Each time the advertisement is displayed on the display sections of the user terminals 5 (distributed to the user terminals 5), a value in the display count field is incremented. Each time the advertisement displayed on the display sections of the user terminals 5 is clicked, the fact is notified to the advertisement server 3, and a value in the click count field is incremented.

With the CTR field, CTRs, a kind of an index value indicative of the advertisement effectiveness, are registered. The CTR is calculated by dividing the click count by the display count. It can be said that the higher the CTR value is, the higher the advertisement effectiveness is.

With the access count field, the access counts (page views) to the web pages on which the advertising areas are set is registered.

With the conversion count field, the numbers of accesses at which the final outcomes (for example, a product purchase or a request for written information) desired by the advertiser are reached are registered.

Each time the web page to which the advertising area is set is accessed, the fact is notified to the advertisement server 3 and a value of the access count is incremented. Additionally, each time the final outcome (for example, the product purchase or the request for written information) desired by the advertiser is reached, the fact is notified to the advertisement server 3 and the value of the conversion count is incremented.

With the CVR field, CVRs, a kind of an index value indicative of the advertisement effectiveness, are registered. The CVR is calculated by dividing the conversion count by the access count. It can be said that the higher the value of the conversion rate is, the higher the advertisement effectiveness is. Instead of the access count, a unique user count may be used. The unique user count is counted so as to eliminate an overlap of the number of persons who have accessed the web page to which the advertising area is set.

With the product sales value field, total amounts of sales of products actually purchased in the shop as the advertiser by the users who have clicked the advertisements are registered. Therefore, the product sales value is also a kind of the index value indicative of the advertisement effectiveness. It can be said that the higher the product sales value is, the higher the advertisement effectiveness is.

The display count at the previous adjustment (IMPp) field is a field used for the adjustment process in the embodiment. The IMP count at the time point when the adjustment process is executed is successively registered with the field as a value IMPp. The details will be described later.

### 3. Outline of Adjustment Process of Advertisement Distribution>

The following describes the outline of adjustment process of the advertisement distribution by the advertisement server 3.

An object of the adjustment is to achieve the target IMP count in the distribution period and avoids the IMP count to be biased in the period (the IMP count becomes evenly and appropriate in the period) while maintaining the effective advertisement effectiveness by keeping the distribution condition for the advertising content to some extent.

That is, the intended advertising object is achieved while the effective advertisement effectiveness is provided.

Further preferably, there may be a case where, in addition to achieving the target IMP, too excessive IMP count is avoided.

Although the distribution exceeding the target IMP brings the high advertisement effectiveness and therefore is considered to be preferred for the advertiser, such situation is not desirable in some cases. For example, in the case where an advertising cost varies depending on the IMP count, the IMP count possibly does not match a convenience of a budget of the advertiser. Additionally, the excess in the IMP count excessively to the extent not required by the advertiser means losing a display opportunity of another advertisement for the advertisement trader. Therefore, the target IMP count is achieved as many as possible and then an adjustment so as not to produce the excessive IMP count is executed in some cases.

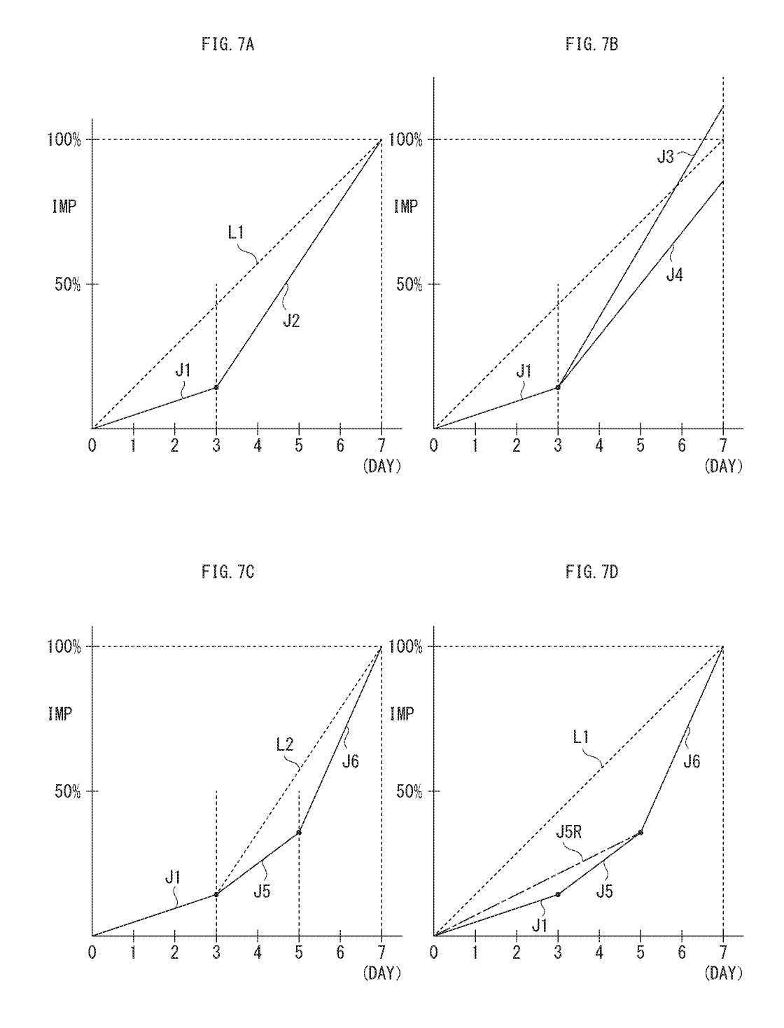

First, the following describes a basic way of thinking of the adjustment process with reference to FIG. 7A.

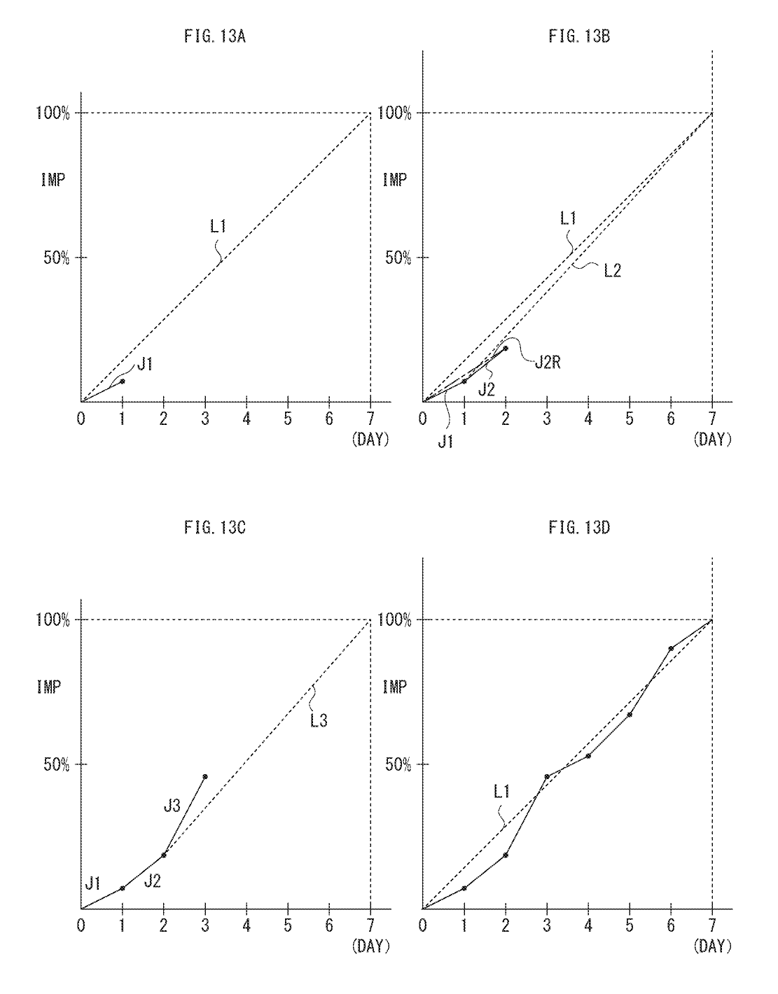

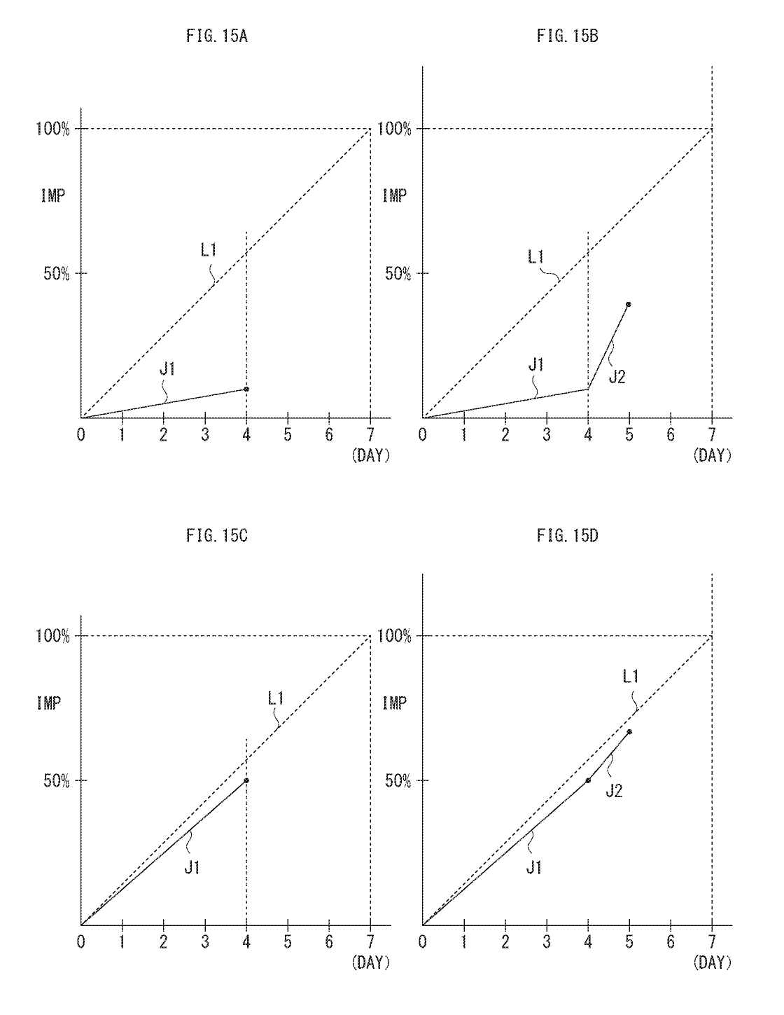

In FIG. 7A, the horizontal axis indicates the time and the vertical axis indicates an achievement percentage of IMP. An example of assuming the distribution period as one week (seven days) is given. While the target IMP is set as, for example, 1000000 impressions and 5000000 impressions, the target value is set to 100% on the vertical axis. The same applies to the vertical axes and the horizontal axes in FIG. 7B, FIG. 7C, and FIG. 7D, and FIG. 13A to FIG. 13D and FIG. 15A to FIG. 15D described later.

The advertisement server 3 (increasing trend determining unit 31) executes the comparison process between the increased gradient value of the IMP count from the start of the distribution until a certain time point before the end of the distribution period and the ideal gradient value of the display count obtained based on the distribution period length and the target display count on the advertising content.

FIG. 7A assumes this “certain time point” as a time point of the third day from the start of the distribution. It is assumed that the IMP count on the third day does not grow as assumed and the increased gradient value is a value of the gradient of the line J1.

Since the IMP count becomes 100% in seven days ideally, the value of the gradient of the line L1 indicated by the dashed line becomes the ideal gradient value.

Here, a comparison between the ideal gradient value as the line L1 and the real increased gradient value as the line J1 turns out to be (ideal gradient value)>(increased gradient value). This suggests a trend failing to achieve the target IMP count. Therefore, the adjustment process adjusts the distribution condition for ease of distribution of this advertising content further.

For example, the targeting condition is relaxed and the appearance ratio is increased.

Obviously, the targeting condition is relaxed in a range without departing from the original advertisement target.

For example, when the targeting condition as the first distribution condition is (from 20 years old to 29 years old) AND (male), the user attribute of “from 30 years old to 39 years old” is added as an OR condition to change as {(from 20 years old to 29 years old) OR (from 30 years old to 39 years old)} AND (male).

For example, with the targeting condition as the first distribution condition being the AND condition of a region, the age group, and the sex, when (residence in the Kanto region) AND (from 20 years old to 29 years old) AND (male) are set, the one residence region of the user attribute is deleted to set the AND condition with the age group and the sex of (from 20 years old to 29 years old) AND (male).

By thus adjusting the distribution condition, the increase in the distribution frequency is expected. For example, as indicated by the line J2, the increase in the IMP count increases a possibility of making an object IMP achievable.

Although not illustrated in the drawing, with (ideal gradient value)<(increased gradient value) met, since the IMP count grows too much as assumed conversely, the distribution condition is set to be strict. That is, the appearance ratio is lowered and the targeting condition is set to be strict.

To set the targeting condition strictly, for example, the condition (from 20 years old to 29 years old) AND (male) is set to be, for example, (residence in the Kanto region) AND (from 20 years old to 29 years old) AND (male), considering the sell area of the product to set the targeting condition strictly.

To change the targeting condition, preliminarily setting the condition elements that can be added to or deleted from the distribution condition as the AND conditions or the OR conditions is appropriate. Therefore, as illustrated in FIG. 4, the condition elements appropriate as the targeting conditions are preliminarily registered as the allowable user attributes.

For example, as the allowable user attributes of a certain product A, for example, “from 20 years old to 29 years old,” “from 30 years old to 39 years old,” “from 15 years old to 19 years old,” “male,” “residence in Japan,” “residence in the Kanto region,” and “residence in Tokyo” are registered. In this case, it is assumed that the user attribute as the initial targeting condition is selected as, for example, “from 20 years old to 29 years old,” “male,” and “residence in Japan.”

The user attribute is relaxed or strengthened such that the condition element is added and deleted in a range of these allowable user attributes. This allows adjusting the number of distributions while maintaining the assumed range of the users to be the initial target.

However, obviously, the one-time adjustment does not always produce the appropriate IMP count. For example, even when the adjustment is executed at the time point of the third day from the start of the distribution and the distribution frequency increases, the rate of growth is not sufficient, and the line becomes like the line J4 in FIG. 7B, possibly failing to reach the target IMP count at the time point of the end of the distribution. Alternatively, the IMP count possibly becomes excessive like the line J3.

Therefore, executing the adjustment several times in the distribution period is also appropriate.

For example, FIG. 7C illustrates an example where the adjustment is also executed at the time point of the fifth day after the adjustment on the third day. It is assumed that, after the adjustment on the third day, the actual IMP count transitions as indicated by the line J5. Then, the adjustment is executed again at the time point of the fifth day. That is, the real increased gradient value and the ideal gradient value are compared at the time point of the fifth day and the distribution condition is adjusted according to the comparison result. Thus, an advertisement distribution opportunity is adjusted, and the IMP count is in a state where the appropriate growth can be expected, for example, as indicated by the line J6.

FIG. 7C and FIG. 7D are possible examples as the examples of the increased gradient value and the ideal gradient value at the adjustment at the second time or later.

FIG. 7C is an example in which the ideal gradient value is a value of the gradient of the line L2 and the increased gradient value is a value of the gradient of the line J5.

The line L2 is a line targeting 100% at the final time point with the IMP count (achievement percentage (%)) at the previous adjustment time point (the time point of the third day) as its origin. The line J5 becomes the gradient according to the IMP result under the adjusted distribution condition. Therefore, with the use of the line J5 as the increased gradient value, the appropriate comparison cannot be executed unless the IMP count at the previous adjustment time point is set as a reference. Therefore, the ideal gradient (namely, the gradient of the line L2) needs to be used under the adjusted distribution condition.

Meanwhile, FIG. 7D is an example in which the ideal gradient value is the value of gradient of the line L1 similarly to the previous time and the increased gradient value is a value of the gradient of the line L5R of the IMP count (achievement percentage) from the start of the distribution until the time point of the fifth day.

The gradient of the line J5 shows the trend from the third day until the fifth day and therefore is not the trend of the entire distribution period. This is because unless the IMP count from the start of the distribution until the fifth day is targeted certainly, the comparison with the line L1 cannot be executed.

Any example of FIG. 7C and FIG. 7D may be used for the comparison process for the adjustment in the embodiment.

While the result table 7b of FIG. 6 illustrates the fields of the display count at the previous adjustment (IMPp) as the example, the result table 7b is required in the use of the example of FIG. 7C. The reason is that unless the IMP count at the previous adjustment (at the time point of the third day in FIG. 3C) is stored, the ideal gradient value of the line L2 cannot be calculated. With the use of the example of FIG. 7D, providing the field for the display count at the previous adjustment (IMPp) in the result table 7b is not necessary.

### 4. Distributed Advertisement Selection Process Example I

Next, the following describes the distributed advertisement selection process example I executed by the advertisement server 3 with the function of the advertisement distribution control unit 30. On the premise that the advertisement server 3 executes the distributed advertisement selection processes of the respective examples described later, adjustment processes of the respective examples described later become effective.

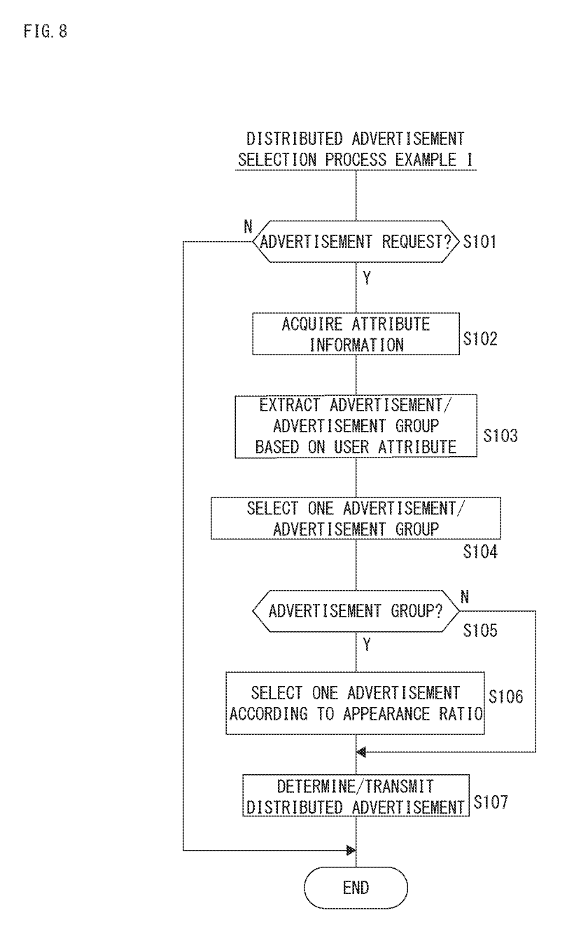

FIG. 8 is a flowchart of the distributed advertisement selection process example I. The advertisement server 3 selects the appropriate advertising content following the distribution condition according to, for example, the advertisement request from the EC server 2 and transmits the advertisement content to the request source.

When receiving the advertisement request at Step S101, the advertisement server 3 advances the process to processes at and after Step S102. At Step S102, the advertisement server 3 acquires the attribute information transmitted together with the advertisement request. The attribute information is information such as the user attribute and the terminal attribute. The information is the user attribute of the user who has requested the web page browse of the EC server 2 using the user terminal 5 and the terminal attribute of the user terminal 5 in use.

At Step S103, the advertisement server 3 extracts the advertising content or the advertisement group based on the acquired user attribute.

This process is to extract the advertising content that is registered with the advertisement table 7a in the advertisement DB 7 and is currently in the distribution period, and is the advertising content whose targeting condition matches the user attribute. That is, the extracted one or the plurality of extracted advertisement(s) or advertisement group(s) are candidates for the distribution of this time.

At Step S104, the advertisement server 3 selects one advertisement or advertisement group among the extracted ones. Since the extracted ones all match the targeting condition, the selection may be executed in random. Obviously, selection of any of a single advertisement or advertisement group may be defined, or the selection order may be determined in the identical targeting condition. The selection method at Step S104 is not specifically defined.

At Step S105, the advertisement server 3 branches the process by whether the advertisement group has been selected or not. When the single advertising content to which the group setting is not configured is selected at Step S104, the process proceeds to Step S107, this advertising content is determined as the advertisement to be distributed, the advertising content is transmitted to the request source, and the process ends.

Meanwhile, when a certain advertisement group is selected at Step S104, the advertisement server 3 advances the process from Step S105 to Step S106, executes the lottery process according to the appearance ratio, and selects the one advertising content in the group. That is, the lottery process is executed with a winning rate set to a state according to the appearance ratio. Then, the process proceeds to Step S107, this selected advertising content is determined as the advertisement to be distributed, the advertising content is transmitted to the request source, and the process ends.

A process example that executes the selection in consideration of the appearance ratio not using the lottery process but setting a selection count according to the appearance ratio and executes the selection in order is also possible. For example, in the case where the appearance ratios of the advertisements A and B are 25% and 75%, respectively, an example in which the selection is executed in the order like the advertisement A→advertisement B→advertisement B→advertisement B→advertisement A→advertisement B . . . is possible.

The above-described distributed advertisement selection process example I executes the advertisement selection according to the settings in the distribution condition, that is, the targeting conditions and the appearance ratios.

### 5. Distributed Advertisement Selection Process Example II

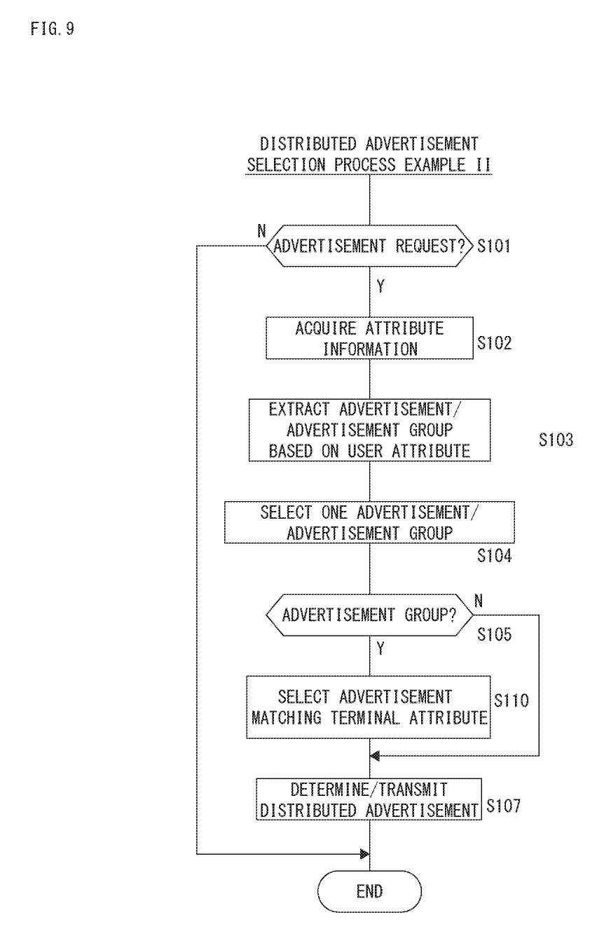

The following describes the distributed advertisement selection process example II with reference to FIG. 9.

Steps S101 to S105 are similar to those of FIG. 8 and therefore the following omits the explanation.

In this example, when a certain advertisement group is selected at Step S104, the advertisement server 3 advances the process from Step S105 to Step S110 and executes the selection according to the terminal attribute.

The terminal attribute is information on the type of the terminal device of the user terminal 5 to which the web page is distributed and the display size of the browser.

The following assumes a plurality of advertisements having different sizes like the advertisements 90 and 91 of FIG. 5A and FIG. 5B as the plurality of pieces of advertising content to which the group setting is configured.

For example, the advertisement 90 of FIG. 5A is an advertisement effective when the display screen of the PC or similar device is comparatively large. Meanwhile, there may be a case where when this advertisement 90 is displayed on the smart phone and the like, the advertisement 90 is not fully displayed in the screen and therefore the entire advertisement 90 cannot be seen unless, for example, the screen is scrolled laterally. In view of this, the advertisement 91 of FIG. 5B is suitable for the effective display of the advertisement.

Accordingly, when the user terminal 5 is, for example, a stationary PC or a notebook PC and has the comparatively large-sized display screen, the advertisement 90 is appropriate. Meanwhile, when the user terminal 5 is a mobile terminal such as the smart phone and has the comparatively small-sized display screen, the advertisement 91 is appropriate.

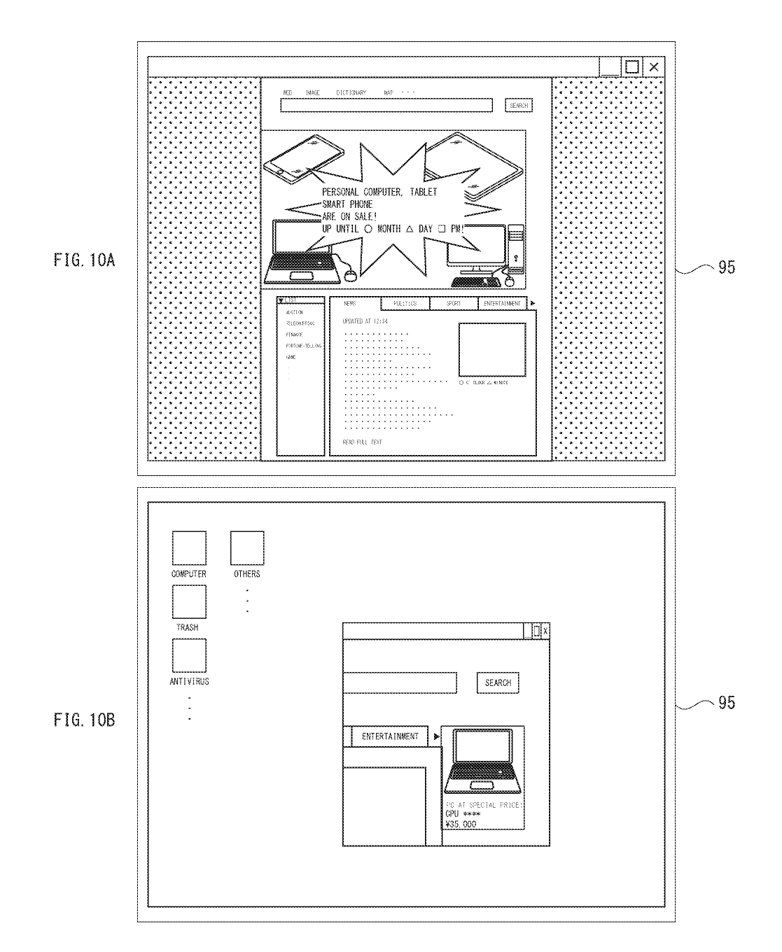

The same thing also happens with the display size of the window. There may be a case where the browser display is small even when the user terminal 5 has the large display screen. FIG. 10A illustrates a state where the web page is displayed using an entire screen 95 of a display device as a window for the browser. Meanwhile, FIG. 10B illustrates a state where the window size of the browser is decreased in the screen 95 of the display device and a part of the web page is displayed.

Thus, in the case where the window size of the browser is decreased even when the device has the large-sized display screen, the small-sized advertisement 91 is suitable for advertisement display of good visibility of the entire advertisement.

Therefore, at Step S110, the advertisement server 3 selects one advertising content in the group according to the device type and the browser window size determined from the acquired terminal attribute. Then, the process proceeds to Step S107, this selected advertising content is determined as the advertisement to be distributed, the advertising content is transmitted to the request source, and the process ends.

In the distributed advertisement selection process example II, the advertisement meeting the targeting condition and suitable for the browsing environment for the user terminal 5 is selected.

### 6. Distributed Advertisement Selection Process Example III

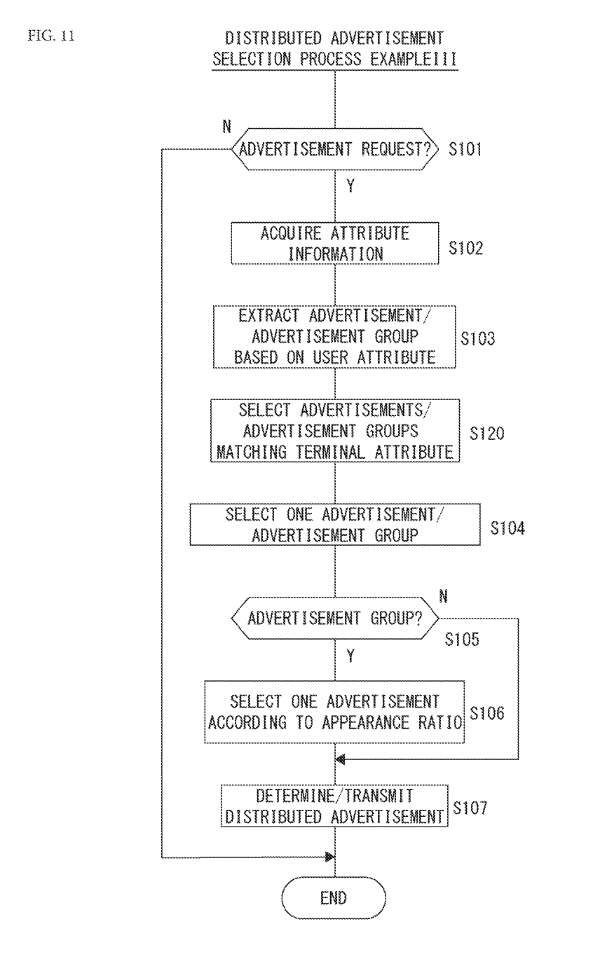

The following describes the distributed advertisement selection process example III with reference to FIG. 11.

Steps S101 to S103 and Steps S104 to S107 are similar to those of FIG. 8.

In this example, after the advertisements or the advertisement groups whose targeting conditions match the user attributes are extracted based on the user attributes at Step S103, the advertisements or the advertisement groups matching the terminal attribute are further extracted from the extracted advertisements or advertisement groups at Step S120.

For example, the advertising attributes of the respective advertisements registered with the advertisement table 7a are referred to extract the advertisements or the advertisement groups matching the browsing environment of the user terminal 5. Accordingly, the advertisements or the advertisement groups extracted at Step S120 are the advertisements matching the terminal attribute.

Then, at Step S104, the advertisement server 3 selects one advertisement or advertisement group among the extracted ones to execute processes of Steps S105 to S107.

In this distributed advertisement selection process example III as well, the advertisement with the user attribute and the terminal attribute as the targeting condition matched is selected. Especially, in this example, regardless of the group setting, the selection to ensure the display with good browsability of the respective pieces of advertising content can be achieved.

To use this process, the advertisement group preferably includes pieces of advertising content all of which have approximately similar image sizes.

Note that the advertisement group including at least one advertising content that matches the terminal attribute in terms of size may be included as the extraction target at Step S120. In that case, even when the advertisement group is selected at Step S104, it is only necessary to refer to a terminal condition in addition to the appearance ratio at the stage of Step S106 to select one advertising content.

While the above-described distributed advertisement selection process examples II and III assume the display size as the browsing environment of the terminal as the terminal attribute, for example, a difference in processing capability depending on the terminal type may be considered.

For example, when a moving image/still image is present as the advertising content, it is considered that the moving image is selected for a PC or the like, which is assumed to have higher capability, and the still image is selected for a model having comparatively small processing capability.

Obviously, an example of selecting the advertisement considering the display size and the processing capability together is also possible.

### 7. Adjustment Process Example I

As described above, when the advertisement server 3 selects the advertisement matching the distribution condition as described above by the function of the advertisement distribution control unit 30, the administrator of the advertisement server 3 cannot adjust the IMP count of each advertisement in an arbitrary manner. However, it is required to achieve the target IMP count in the distribution period and the IMP count is not biased in the period while meeting the distribution condition and maintaining the advertisement effectiveness. Therefore, the advertisement server 3 executes an adjustment process like the following adjustment process examples I, II, and III by functions of the increasing trend determining unit 31 and the distribution condition adjusting unit 32.

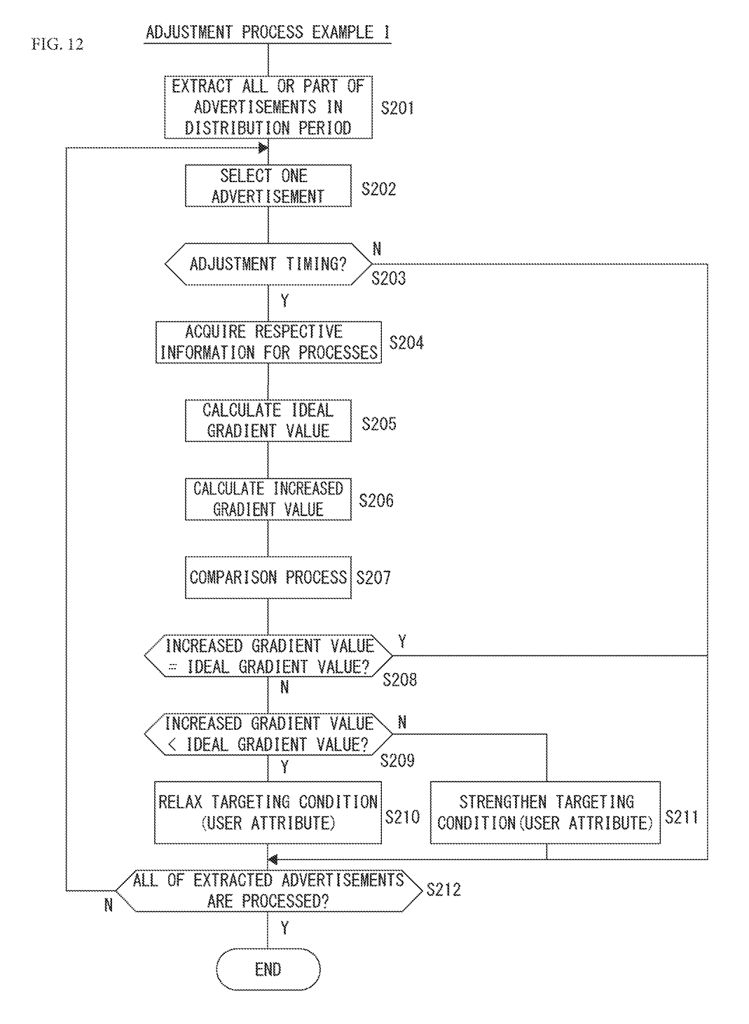

First, the following describes the adjustment process example I with reference to FIG. 12 and FIG. 13. FIG. 12 is a flowchart of the adjustment process example I. FIG. 13 includes drawings describing operations in the adjustment process example I.

This adjustment process example I is an example that executes the comparison process of the real increased gradient value and the ideal gradient value at every elapse of unit period in a period from the start of the distribution of the advertising content until the end of the distribution and relaxes or strengthens a fixed width or a fixed count of the distribution condition according to the result of the comparison process.

The relaxation or strengthening of the fixed width of the distribution condition means, for example, increase or decrease in the fixed width of the value of the appearance ratio under the targeting condition. Additionally, the relaxation or strengthening of the fixed count of the distribution condition means deletion and addition of the fixed count (for example, one) of the condition element.

The following describes the operations with reference to FIG. 13. It is assumed that the adjustment process is executed at every time point of the end of one day with the distribution period set to, for example, seven days.

FIG. 13A illustrates the line J1 according to the real IMP count at the time point of the end of the first day and the line L1 indicative of the ideal gradient value. This shows a state where the IMP count does not grow as assumed. The gradient value and the increased gradient value of the line J1 are smaller than those of the ideal gradient value. Therefore, the distribution condition is relaxed at this time point. The adjustment in this case is, for example, deletion and addition of the fixed count (for example, one) of the user attribute as the targeting condition. That is, the adjustment is to delete one AND condition element or add one OR condition element. Alternatively, the adjustment is an addition of fixed % (for example, 5%) of the appearance ratio. For example, the appearance ratio is adjusted from 30% to 35%.

The adjustment is also executed at the time point of the end of the second day. FIG. 13B illustrates the line J2 (or the line J2R) of the real IMP count at the time point of the end of the second day.

The line J2 is a line indicative of the increased gradient value from the end of the first day until the end of the second day.

The line J2R is a line indicative of the increased gradient value from the time point of the start of the distribution period until the end of the second day. As described with FIG. 7C and FIG. 7D, with the use of the line J2 as the increased gradient value, the gradient value of the line L2 is used as the ideal gradient value. With the use of the line J2R as the increased gradient value, the gradient value of the line L1 is used as the ideal gradient value.

At the time point of this second day as well, the fixed width of the distribution condition is relaxed or strengthened based on the comparison result between the increased gradient value and the ideal gradient value.

Further, FIG. 13C illustrates a state at the end of the third day. Here, in FIG. 13C, the line J3 and the line L3 of the ideal gradient value with the use of the method of FIG. 7C are denoted.

At the stage of this third day as well, the fixed width of the distribution condition is relaxed or strengthened based on the comparison result between the increased gradient value and the ideal gradient value.

For example, the adjustment in each day allows adjusting the increasing trend of the IMP count, thereby increasing a possibility of reaching the target IMP count at the time point of the end of the distribution period. FIG. 13D illustrates a state where the periodical adjustment of the distribution condition adjusts the increasing trend of the IMP count and consequently the target IMP count is reached.

Note that the target IMP count may be set slightly higher than the actual target IMP count. For example, with the target IMP count=1000000, the adjustment process sets the target IMP count=1010000. Since the adjustment converges to the target IMP count, there is a possibility that the IMP count actually slightly falls below the target IMP count finally. Therefore, considering at least achieving the target IMP count, the adjustment process is desirably executed with the target IMP count set slightly higher than the actual target IMP count. The same applies to the adjustment process examples II and III described later.

The following describes processes by the advertisement server 3 to achieve the adjustment process like FIG. 13 with reference to FIG. 12. The advertisement server 3 repeatedly executes the processes of FIG. 12, for example, always or periodically.

At Step S201, the advertisement server 3 extracts all or a part of the pieces of advertising content currently in the distribution period among the pieces of advertising content registered with the advertisement table 7a as the process targets.

Note that a part of the pieces of advertising content are extracted considering presence of, for example, the advertisement to which the target IMP count is set, the advertisement to which the target IMP count is not set, or the advertisement whose distribution period is unsettled. An advertisement where the target IMP count and the distribution period are set but the adjustment is unnecessary in particular is possibly present. At Step S201, the pieces of advertising content required to be adjusted are extracted.

At Step S202, the advertisement server 3 selects one advertising content among a large number of pieces of extracted advertising content to which the adjustment is required as the process target.

At Step S203, the advertisement server 3 confirms whether the advertising content is currently at the adjustment timing or not. For example, with the timing of every 24 hours, it is confirmed whether the advertising content reaches the timing at the time point of 24 hours or not. When not at the adjustment timing, the process proceeds to Step S212. When the confirmation is not completed on all pieces of extracted advertising content, the process returns to Step S202, and the one advertising content is selected as the process target.

When the advertisement server 3 determines that the advertising content as the process target is currently at the adjustment timing, the process proceeds from Steps S203 to S204 and the advertisement server 3 acquires information necessary to calculate the ideal gradient value and the increased gradient value of the advertising content and to execute the subsequent adjustment process from the advertisement DB 7. Specifically, the information on the distribution period, the target IMP, the distribution condition, the advertising attribute, and the allowable user attribute is acquired from the advertisement table 7a. Additionally, the advertisement server 3 acquires the display count (IMP) from the result table 7b. Depending on the process method, the advertisement server 3 also acquires the display count at the previous adjustment (IMPp).

At Step S205, the advertisement server 3 calculates the ideal gradient value using the information on the distribution period and the target IMP count. The information on the display count at the previous adjustment is used in some cases.

At Step S206, the advertisement server 3 calculates the increased gradient value using the information on the distribution period and the display count (IMP). The information on the display count at the previous adjustment is used in some cases.

At Step S207, the advertisement server 3 executes the comparison process between the increased gradient value and the ideal gradient value.

At Step S208, the advertisement server 3 confirms whether the comparison result meets the increased gradient value=the ideal gradient value or not. In this case, while only whether the increased gradient value perfectly matches the ideal gradient value or not may be determined, whether the increased gradient value the ideal gradient value is met or not may be determined. That is, whether they match in a certain amount of allowable range or not may be determined. For example, it is determined whether they are different to the extent that the distribution condition is to be changed or not.

When the increased gradient value matches (or is regarded to match) the ideal gradient value, the advertisement server 3 determines that the distribution condition for the advertising content needs not to be adjusted and the process proceeds to Step S212.

When the increased gradient value does not match (or is not regarded to match) the ideal gradient value, the advertisement server 3 advances the process to Step S209 and branches the process depending on which is larger than the other between the increased gradient value and the ideal gradient value.

That is, with the increased gradient value<the ideal gradient value met, the advertisement server 3 advances the process to Step S210 and relaxes the user attribute as the targeting condition. That is, one AND condition element as the user attribute is deleted or one OR condition element as the user attribute is added. In this case, instead of the change in the user attribute or together with the change in the user attribute, the fixed width of the appearance ratio may be increased.

Specifically, at Step S210, the advertisement server 3 sets the distribution condition thus adjusted to be relaxed and updates the information content of the distribution condition in the advertisement table 7a of this advertising content. Then, the process proceeds to Step S212.

With the increased gradient value>the ideal gradient value met, the advertisement server 3 advances the process to Step S211 and strengthens the user attribute as the targeting condition. That is, one AND condition element as the user attribute is added or one OR condition element as the user attribute is deleted. In this case, instead of the change in the user attribute or together with the change in the user attribute, the fixed width of the appearance ratio may be decreased.

Specifically, at Step S211, the advertisement server 3 sets the distribution condition thus adjusted to be tightened and updates the information content of the distribution condition in the advertisement table 7a of this advertising content. Then, the process proceeds to Step S212.

After executing the above-described processes on all pieces of advertising content extracted at Step S201, the advertisement server 3 ends the sequence of adjustment processes at Step S212.

To change the appearance ratio, an appearance ratio of another competitive advertising content may be changed. That is, regarding the advertising content whose IMP count is desired to increase, the appearance ratio of the competitive advertising content is lowered. Regarding the advertising content where the increase in IMP count is reduced, the appearance ratio of the competitive advertising content is increased.

In this case as well, the appearance ratio of the other advertising content only needs to be increased or decreased by, for example, the fixed width.

### 8. Adjustment Process Example II

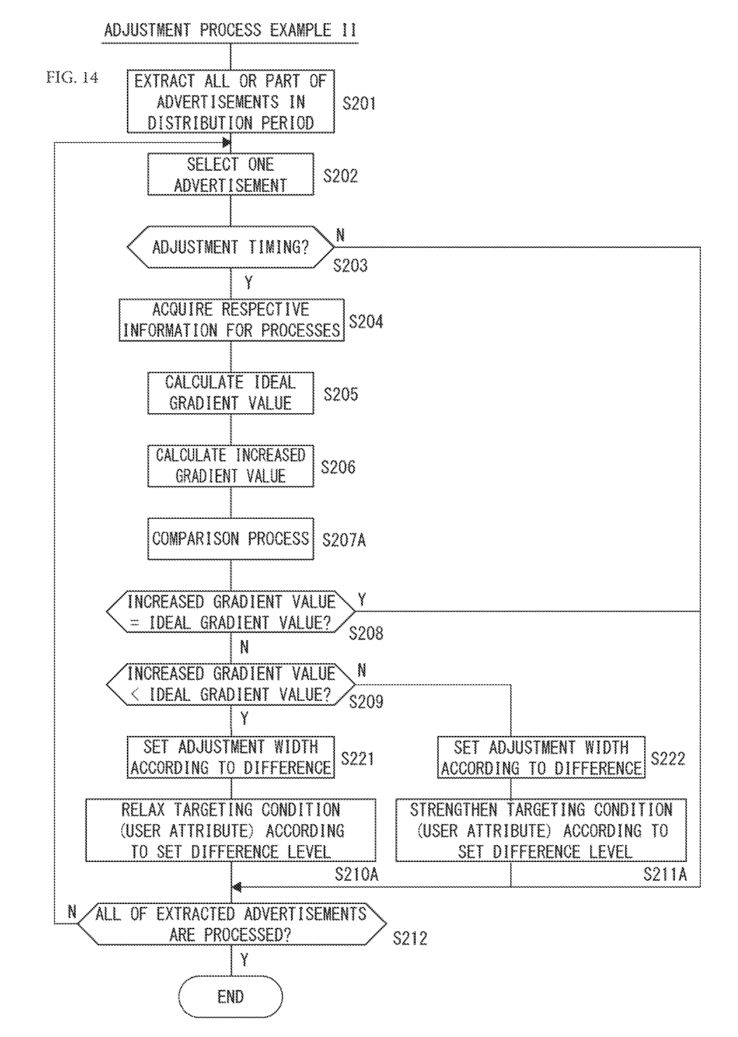

The following describes the adjustment process example II with reference to FIG. 14 and FIG. 15.

This is an example that relaxes or strengthens the variable width or the variable count of the distribution condition according to the difference between the increased gradient value and the ideal gradient value obtained as the result of the comparison process.

That is, the distribution condition is adjusted according to a degree of a difference between the real increased gradient value and the ideal gradient value. The relaxation or the strengthening of the variable width of the distribution condition means a variation of an increase/decrease width of a value of the appearance ratio according to the difference. The relaxation or the strengthening of the variable count of the distribution condition means, for example, a variation of a count of deletion/addition of the condition elements of the targeting condition according to the difference.

FIG. 15A illustrates a situation where the adjustment is executed at a certain time point (the fourth day from the start of the distribution). FIG. 15A illustrates a state where the increased gradient value indicated by the line J1 is comparatively largely different from the ideal gradient value indicated by the line L1. In this case, the distribution condition is significantly relaxed such that the increasing trend (the gradient of the line J2) after the adjustment becomes steep as illustrated in FIG. 15B.

Although FIG. 15C illustrates a situation where the adjustment is similarly executed on the fourth day from the start of the distribution, FIG. 15C illustrates a state where the increased gradient value indicated by the line J1 is not different so much from the ideal gradient value indicated by the line L1. In this case, the distribution condition is only relaxed slightly such that the increasing trend (the gradient of the line J2) after the adjustment becomes gradual as illustrated in FIG. 15D.

The following describes processes by the advertisement server 3 for this situation with reference to FIG. 14. Identical step numbers are attached to processes identical to those of FIG. 12 and the following omits the explanation.

Steps S201 to S206 are similar to those of FIG. 12. In a comparison process at Step S207A, in addition to the comparison of the small and large between the increased gradient value and the ideal gradient value, the advertisement server 3 also obtains the difference.

As a result of the comparison process on certain advertising content, when the increased gradient value does not match (or is not regarded to match) the ideal gradient value, the advertisement server 3 advances the process from Step S208 to Step S209 and branches the process depending on which is larger than the other between the increased gradient value and the ideal gradient value.

With the increased gradient value<the ideal gradient value met, the advertisement server 3 advances the process to Step S221 and sets the adjustment width according to the difference. For example, it is determined whether the difference value between the increased gradient value and the ideal gradient value is equivalent to any of a plurality of stages or not. For example, a level of the degree of difference is determined on the difference, like from a difference level LV1 to a difference level LVn.

The advertisement server 3 relaxes the user attribute as the targeting condition at Step S210A. Here, the relaxation is executed according to the difference level.

For example, assuming the three stages of the difference levels LV1, LV2, and LV3, the respective counts of the user attributes to be added or deleted are set to be different values. For example, one is set for the difference level LV1, two is set for the difference level LV2, and three is set for the difference level LV3.

One AND condition element as the user attribute is deleted or one OR condition element as the user attribute is added by the count according to the difference level.

In this case, instead of the change in the user attribute or together with the change in the user attribute, the width may be increased according to the difference level of the appearance ratio, for example, 5% addition for the difference level LV1, 10% addition for the difference level LV2, and 15% addition for the difference level LV3. The multiplication may be employed instead of the addition.

At Step S210A, the advertisement server 3 sets the distribution condition thus adjusted to be relaxed and updates the information content of the distribution condition in the advertisement table 7a of this advertising content. Then, the process proceeds to Step S212.

With the increased gradient value>the ideal gradient value met, the advertisement server 3 advances the process to Step S222 and sets the adjustment width according to the difference. The advertisement server 3 strengthens the user attribute as the targeting condition according to the difference level at Step S211.

For example, one AND condition element as the user attribute is added or one OR condition element as the user attribute is deleted by the count according to the difference level.

In this case as well, instead of the change in the user attribute or together with the change in the user attribute, the width may be decreased according to the difference level of the appearance ratio, for example, 5% subtraction for the difference level LV1, 10% subtraction for the difference level LV2, and 15% subtraction for the difference level LV3. A reciprocal multiplication may be employed instead of the subtraction.

At Step S211A, the advertisement server 3 sets the distribution condition thus adjusted to be strengthened and updates the information content of the distribution condition in the advertisement table 7a of this advertising content. Then, the process proceeds to Step S212.

The process of Step S212 is similar to that of FIG. 12.

To change the appearance ratio, an appearance ratio of another competitive advertising content may be changed. That is, regarding the advertising content whose IMP count is desired to increase, the appearance ratio of the competitive advertising content is lowered. Regarding the advertising content where the increase in IMP count is reduced, the appearance ratio of the competitive advertising content is increased.

In this case, the increase/decrease widths only need to be different according to the degree of difference.

Not the example of dividing the degree of difference between the increased gradient value and the ideal gradient value into the stages according to the difference levels but executing a coefficient multiplication on the difference value and setting the adjustment width are also considered.

### 9. Adjustment Process Example III

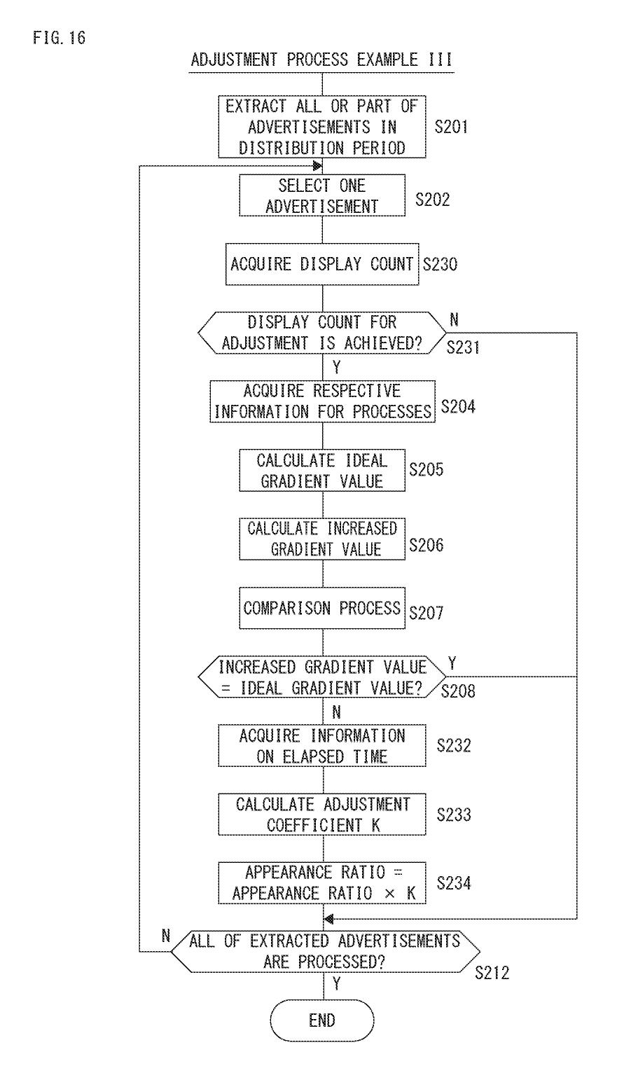

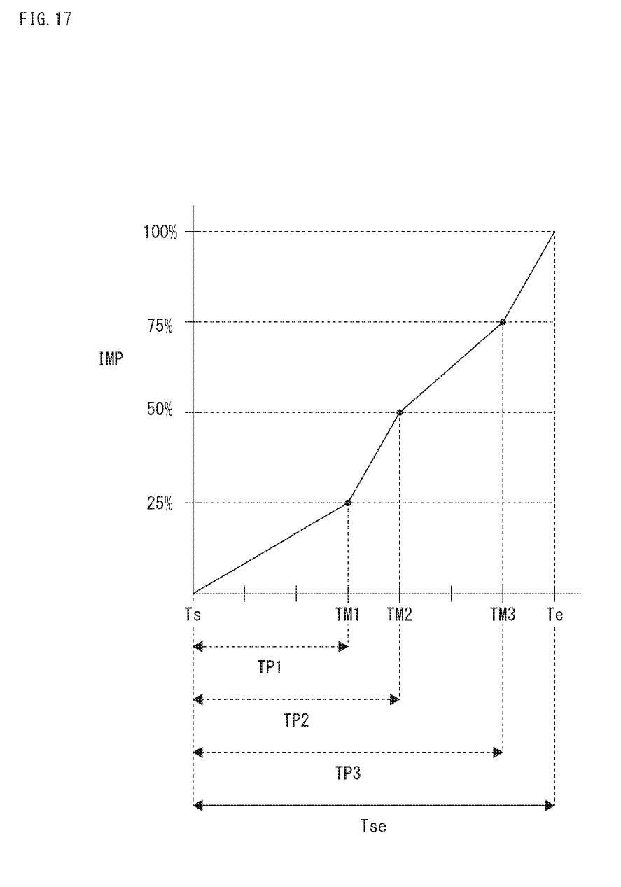

The following describes the adjustment process example III with reference to FIG. 16 and FIG. 17.

This is an example that executes the comparison process according to the display count of the advertising content reaching a predetermined stage and relaxes or strengthens the distribution condition using a coefficient when the adjustment is determined as necessary from the result of the comparison process. The coefficient is obtained using a distribution period length and an elapsed period length.

For example, FIG. 17 illustrates an example where at timings when the IMP count reaches the predetermined stages, which are the IMP count reaches 25%, reaches 50%, and reaches 75% of the target, the comparison process is executed between the increased gradient value and the ideal gradient value, and when determined as required from the comparison result at the time, the distribution condition is adjusted with the coefficient calculated from the distribution period length and the elapsed time until the time point.

The horizontal axis in FIG. 17 indicates a distribution period from a distribution starting time point Ts until a distribution ending time point Te. The vertical axis indicates the IMP count by the achievement percentage (%).

FIG. 17 illustrates a state where the adjustments are executed at respective time point TM1 with the IMP count of 25%, time point TM2 with the IMP count of 50%, and time point TM3 with the IMP count of 75%, the increasing trend of the IMP count changes, and finally the IMP count reaches the target IMP count.

Here, it is assumed that the appearance ratio of the advertising content is adjusted. A coefficient K acquired using the distribution period length and the elapsed period length is multiplied to relax or strengthen the distribution condition regarding the appearance ratio.

As illustrated in the drawing, an elapsed time from the start is denoted as TP, elapsed time lengths up to time points TM1, TM2, and TM3 are denoted as TP1, TP2, and TP3, respectively. A period length of the entire distribution period is denoted as Tse.

25%, 50%, or 75% as the IMP count is denoted as y. Note that y is a value of the percentage of the achievement percentage, and y=25 at 25%.

In this case, the coefficient K can be obtained as follows.

K=(100−y)/{(Tse/TP)y−y}

For example, the respective coefficients K with the IMP counts of 25%, 50%, and 75% are obtained as follows:

K=(100−25)/{(Tse/TP1)25−25}

K=(100−50)/{(Tse/TP2)50−50}

K=(100−75)/{(Tse/TP3)75−75}

By obtaining the coefficient K to adjust the appearance ratio, the adjustment becomes more effective.

The following describes processes by the advertisement server 3 for this situation with reference to FIG. 16. Identical step numbers are attached to processes identical to those of FIG. 12 and the following omits the explanation.

Steps S201 and S202 are similar to those of FIG. 12.

At Step S230, the advertisement server 3 acquires the current display count (IMP) of the advertising content selected as the process target at Step S202 from the result table 7b. At Step S231, the advertisement server 3 confirms whether the advertising content is currently at the adjustment timing or not. That is, whether the current IMP count corresponds to any of 25%, 50%, and 75% of the target IMP count or not is determined.

Since the IMP constantly increases and the adjustment process is not always executed on all advertisements, there is a time lag between a time at which the achievement percentage actually reaches the predetermined achievement percentage and the time of this adjustment process. Actually, at Step S231, it is only necessary to determine whether the advertising content is in the first process opportunity after, for example, 25%, 50%, or 75% of the achievement percentage is exceeded first or not. Obviously in the case, it is only necessary to use the actual IMP count (y=the achievement percentage at the time point of the process) as the acquired display count and use the elapsed time from the start of the distribution at the time point of the process as the elapsed time. For example, with the achievement percentage of 25.1% at the time point of the process, it is only necessary to use y=25.1 in the formula to obtain the above-described coefficient K and use the elapsed time until the time point of the process as the elapsed time TP.

When not at the adjustment timing, the advertisement server 3 advances the process to Step S212. When the confirmation is not completed on all pieces of extracted advertising content, the process returns to Step S202, and the one advertising content is selected as the process target.

When the advertising content as the process target is at the adjustment timing, the advertisement server 3 advances the process at and after Step S204. Steps S204 to S208 are similar to those of FIG. 12.

As a result of executing the comparison process on certain advertising content at Step S207, when the increased gradient value does not match (or is not regarded to match) the ideal gradient value, the advertisement server 3 advances the process from Step S208 to S232 and acquires the information on the elapsed time. That is, the advertisement server 3 obtains the elapsed time TP from the start of the distribution until the present.

At Step S233, the advertisement server 3 calculates the adjustment coefficient K. The achievement percentage of IMP at the time point is denoted by y and the acquired elapsed time TP and the period length Tse of the distribution period are used for the operation of the above-described formula to obtain the adjustment coefficient K.

At Step S234, the appearance ratio set to this advertising content is multiplied by the coefficient K. The information content of the distribution condition in the advertisement table 7a of this advertising content is updated with the multiplication result as a new appearance ratio after the adjustment. The process proceeds to Step S212. The process of Step S212 is similar to that of FIG. 12.

In this case as well, the appearance ratio of another competitive advertising content may be changed. The appearance ratio of the competitive content is changed to be similar to the case where the appearance ratio of the process-target advertising content is multiplied by the coefficient K to increase and decrease the appearance ratio.

The calculation formula of the coefficient K is one example. For example, the use of the remaining time at each time point such as the time points TM1 and TM2 allows the similar calculation.

### 10. Summary and Modifications

With the above-described embodiment, the following effects are acquired.

The advertisement server 3 of the embodiment includes the advertisement distribution control unit 30. The advertisement distribution control unit 30 selects the advertising content for distribution to the user terminal 5 in accordance with the distribution condition set to each piece of content. The advertisement server 3 includes the increasing trend determining unit 31. The increasing trend determining unit 31 executes the comparison process between the increased gradient value of the display count from the start of the distribution until a certain time point before the end of the distribution period and the ideal gradient value of the display count obtained based on the distribution period length and the target display count of the content selected for distribution to the user terminal 5 by the advertisement distribution control unit 30. The advertisement server 3 further includes the distribution condition adjusting unit 32 that changes the distribution condition such that the distribution frequency of this content is varied according to the comparison result by the increasing trend determining unit 31.

That is, the distribution condition set to each advertising content is adjusted based on the comparison result between the increased gradient value and the ideal gradient value such that the target display count (IMP count) is achieved in the planned constant distribution period

This ensures the adjustment such that the possibility of achieving the target IMP count of the distribution of the advertising content in the distribution period becomes high. The comparison between the actual increased gradient value as the IMP count of the advertising content and the ideal gradient value allows the determination whether the current distribution condition for the advertisement is proper, strict, or loose. That is, obtaining the actual increased gradient value and comparing this value with the ideal gradient value allows a prediction whether the target IMP count is reached with the current distribution condition or is difficult to be reached at comparatively high accuracy. Therefore, adjusting the distribution condition according to the prediction allows improving the probability of reaching the target IMP count at the time point of the end of the distribution period.

With the process of the embodiment, the advertisement distribution is adjustable such that the distribution is executed without the bias of the display count on the time axis in the distribution period. The actual increased gradient value being close to the ideal gradient value is likely to suggest that the distribution is executed without the bias in terms of time in the distribution period. Therefore, adjusting the distribution condition such that the actual distribution approaches the ideal gradient can achieve the distribution in which the display is executed evenly as much as possible in the distribution period.

It is only necessary to calculate the real increased gradient value and compare this value with the ideal gradient value as the operation of the distribution condition change determination. This is effective in terms of ease of arithmetic processing for adjustment and avoiding an increase in processing load on the advertisement server 3.

The comparison between the increased gradient value and the ideal gradient value allows the adjustment in the case where the IMP count largely exceeds the target IMP count. There may be a case where the IMP count is not desired to be excessive, and this adjustment is effective to such case.

Since the distribution condition is changed while maintained in the allowable range to some extent, the distribution based on the advertisement targeting is appropriately executed. That is, the distribution is not randomly executed for people utterly out of the target to grow the number of distributions; therefore, the distribution condition is adjusted while the advertisement distribution brining the high advertisement effectiveness can be maintained.

From the viewpoint of the users, a state in which the advertisement assumed to be worthwhile for the users can be maintained to be presented in the limited (for example, a monitor) presentation area in the user terminal.

In the adjustment process example I of the embodiment, the comparison process is executed at every elapse of the unit period in the period from the start of the distribution until the end of the distribution of the advertising content, and the fixed width or the fixed count of the distribution condition is relaxed or strengthened according to the result of the comparison process.

In this case, since the distribution condition is finely adjusted successively according to the result of the IMP count periodically, a possibility that the target display count (or the vicinity of the target display count) is reached at the end of the distribution while the distribution is executed without the bias in terms of the count in the distribution period can be improved.

The relaxation or the strengthening of the distribution condition with the fixed width and the fixed count ensures simplifying an algorithm to adjust the distribution condition, thereby ensuring reducing a processing load on the server.

The adjustment process example II of the embodiment relaxes or strengthens the variable width or the variable count of the distribution condition according to the difference between the increased gradient value and the ideal gradient value obtained as the result of the comparison process.

The change in the distribution condition with the variable width allows making the gradient of the real display count close to the ideal gradient early. In view of this, the possibility that the target display count is reached at the end of the distribution period can be further improved.

In the adjustment process example III of the embodiment, the comparison process is executed according to the display count of the advertising content reaching the predetermined stage and when the adjustment is determined as necessary from the result of the comparison process, the distribution condition is relaxed or strengthened using the coefficient K, which is obtained using the distribution period length and the elapsed period length.

In view of this, adjustment is executed according to the progress of the IMP count. While the time lengths until the respective stages are reached differ between the respective pieces of advertising content depending on the progress of the distribution of the advertising content, the use of the coefficient K according to the distribution period length and the elapsed period length for the adjustment allows the adjustment to reach the target display count at the end of the distribution at good accuracy.

The embodiment has described the example in which at least the targeting condition (the user attribute or the terminal attribute) indicative of the attribute of the distribution destination is set to each piece of advertising content as the distribution condition and the distribution condition is relaxed or strengthened by increasing or decreasing the count of the attribute (for example, the user attributes) of the distribution destination as the targeting condition set to the advertising content.

The increase or decrease of the count of the attribute of the distribution destination allows effectively adjusting the IMP increasing trend.

The increase or decrease in the count of the user attribute do not break the way of thinking of the advertisement targeting but change the range of the advertisement targeting while narrowing down the target and therefore are also suitable as the targeting advertisement method.

Not only the user attributes but also the terminal attributes may be increased and decreased.

The embodiment has described the example in which the appearance ratio indicative of the relative probability of being selected for the distribution between the plurality of pieces of advertising content is set and the distribution condition is relaxed or strengthened by changing the appearance ratio set to the advertising content.

For example, the distribution ratios are adjustable by setting the respective appearance ratios to the plurality of pieces of advertising content (the pieces of advertising content to which the group setting is configured) having the targeting conditions all or a part of which are common. For example, with the two pieces of content, the advertisement A and the advertisement B, having the appearance ratios of 30% and 70%, respectively, when the corresponding targeting conditions are met, the distribution control unit selects and distributes the advertisement A with the probability of 30% and selects and distributes the advertisement B with the probability of 70%.

Therefore, changing the appearance ratio can adjust the display count effectively. Especially, in the case where a plurality of advertisements having the identical targeting conditions are distributed, the effective adjustment is executable such that the respective advertisements reach the target IMP count without one advertisement becomes prominent.

The adjustment process examples I, II, and III of the embodiment have described the modifications that the distribution condition of another competitive content may be changed such that the distribution frequency of the content target for the comparison process is varied. For example, considering the plurality of pieces of content (pieces of competitive content) having the targeting conditions all or a part of which are common, to adjust a distribution frequency of certain content, a distribution frequency of another competitive content may be changed. That is, relatively adjusting the distribution frequency allows accelerating and decelerating the progress of the display count of the certain content.

The method is one preferable method especially to adjust the plurality of pieces of content having the common targeting conditions. This method is effective especially in the case where the display count is biased to the one content.

The embodiment has described the example in which the information on the terminal attribute of the user terminal 5 as the distribution destination is acquired and the content for distribution to the user terminal 5 is selected using the acquired information on the terminal attribute as the distributed advertisement selection process examples II and III.

For example, the advertising content to be distributed is selected according to, for example, whether the terminal device is a PC (personal computer) such as a so-called stationary PC and a notebook PC or a portable device such as a smart phone. For example, when the image sizes of the advertisements have different lengths in sizes of lateral widths, the advertisement having the long size is selected for the PC as the terminal device and the advertisement having the short size is selected for the smart phone as the terminal device.

Thus, considerably desirable advertisement display is achievable. For example, with the smart phone or similar device having the small screen size, the advertisement having the long lateral width fails to be entirely displayed or is excessively reduced, thereby deteriorating the advertisement effectiveness. Meanwhile, such advertisement displayed on the large screen of the PC and the like brings considerably large appealing effect to the users. Additionally, although the advertisement having the short lateral width size does not stand out on the PC, when displayed on the device such as the smart phone, the advertisement has a large appealing power to the users.

Since such situation occurs, selecting the advertisement according to the information on the terminal attribute such as the type of the user terminal 5 allows achieving the distribution to maximally provide the advertisement function.

Meanwhile, in this case, the selection of the advertisement is defined by the user terminal 5 to some extent. Accordingly, a possibility that each advertising content fails to reach the target IMP count in the distribution period and a possibility that the target IMP count is largely exceeded increase.

Therefore, the distribution condition is successively adjusted. For example, the targeting condition is adjusted. In view of this, the respective advertisements can be controlled so as to reach the target IMP count in the distribution period, thereby being considerably effective to the advertisement distribution to which the target IMP count is set.

The distributed advertisement selection process examples II and III have mentioned that the information on the display size on the user terminal 5 as the distribution destination is acquired and the content for distribution to this user terminal 5 is selected using the acquired information on the display size.

Since the web page is displayed by the browser started on the terminal device, its display size depends on the size of the display area assigned to the browser. For example, the most PC users not only display the browser on the entire screen but display the browser on a part of the display screen in some cases. Therefore, the exposed state of the content to the users changes depending on the browser display size at the time point of distribution. Therefore, the suitable content is selected according to the display size.

Thus, considerably desirable advertisement display is achievable. For example, with the small display size, for example, the advertisement having the long lateral width fails to be entirely displayed or is excessively reduced, thereby deteriorating the advertisement effectiveness. Meanwhile, such advertisement brings the considerably large appealing effect to the users with the large display size. Additionally, the advertisement having the short lateral width size is effective even with the small display size.

Therefore, selecting the advertisement according to the display size allows achieving the distribution to maximally provide the advertisement function.

Meanwhile, in this case, the selection of the advertisement is defined by the display size state of the user terminal to some extent. Accordingly, the possibility that each advertising content fails to reach the target IMP count in the distribution period and the possibility that the target IMP count is largely exceeded increase. Therefore, the distribution condition is successively adjusted. For example, the targeting condition is adjusted. In view of this, the respective advertisements can be controlled so as to reach the target IMP count in the distribution period, thereby being considerably effective to the advertisement distribution to which the target IMP count is set.

While the embodiment has given the description mainly assuming the advertising content, the present invention is applicable to distribution management of various pieces of content such as distribution of content other than the advertisement, for example, a display of any image used for the web page including various characters and logos displayed on the web page and further a selection of a background image of the web page.

Not only for the website for electronic commerce, the present invention is preferable to control the advertisement distribution on the various websites such as websites for providing various kinds of information and websites of a blog and an affiliate.

### 11. Programs and Storage Mediums

The advertisement server 3 as the embodiment of the information processing device of the present invention has been described above. The program of the embodiment is a program that causes the information processing device configured as the advertisement server 3 to execute the functions as the advertisement distribution control unit 30, the increasing trend determining unit 31, and the distribution condition adjusting unit 32.

The program of the embodiment causes the information processing device to execute the advertisement distribution control function. The advertisement distribution control function selects the content for distribution to the terminal device in accordance with the distribution condition set to each piece of content. That is, the process is the process described as the distributed advertisement selection process examples I, II, and III as the examples.

The program causes the information processing device to execute: the comparison process between the increased gradient value of the display count from the start of the distribution until a certain time point before the end of the distribution period and the ideal gradient value of the display count obtained based on the distribution period length and the target display count; and the process that changes the distribution condition such that the distribution frequency of the content is varied according to the comparison result. That is, the processes are the processes described as the adjustment process examples I, II, and III as the examples.

Such programs allow achieving the above-described one or plurality of information processing devices as the advertisement servers 3.

Then, such program can be preliminarily stored in an HDD as a storage medium incorporated in equipment such as a computer device, a ROM in a microcomputer including a CPU, and the like. Alternatively, such program can be temporarily or permanently saved (stored) in a removable storage medium such as a semiconductor memory, a memory card, an optical disk, a magneto-optical disk, and a magnetic disk. Such removable storage medium can be provided as what is called package software.

Such program can be installed into a personal computer and the like from the removable storage medium, and can be downloaded from a download website via a network such as a LAN and the Internet.

### REFERENCE SIGNS LIST

1 network, 2 EC server, 3 advertisement server, 4 shop terminal, 5 user terminal, 6 e-commerce DB, 7 advertisement DB, 30 advertisement distribution control unit, 31 increasing trend determining unit, 32 distribution condition adjusting unit, 33 DB managing unit

1. An information processing device comprising:
at least one memory configured to store computer program code;
at least one processor configured to access said computer program code and operate as instructed by said computer program code, said computer program code including:
distribution control code configured to cause at least one of said at least one processor to select content for distribution to a terminal device in accordance with a distribution condition set to each piece of content, at least a targeting condition indicative of an attribute of a distribution destination being set as the distribution condition to each piece of content;
increasing trend determining code configured to cause at least one of said at least one processor to execute a comparison process between an increased gradient value of a display count and an ideal gradient value of the display count of the content selected for distribution to the terminal device by the distribution control code, the increased gradient value of the display count being a gradient value from a start of the distribution until a certain time point before an end of a distribution period, the ideal gradient value of the display count being a gradient value obtained based on a distribution period length and a target display count; and
distribution condition adjusting code configured to cause at least one of said at least one processor to relax or strengthen the distribution condition by increasing or decreasing a count of the attribute of the distribution destination as the targeting condition set to the content such that a distribution frequency of the content is varied according to a comparison result by the increasing trend determining code.

2-12. (canceled)

13. An information processing device comprising:
at least one memory configured to store computer program code;
at least one processor configured to access said computer program code and operate as instructed by said computer program code, said computer program code including:
distribution control code configured to cause at least one of said at least one processor to select content for distribution to a terminal device in accordance with a distribution condition set to each piece of content;
increasing trend determining code configured to cause at least one of said at least one processor to execute a comparison process between an increased gradient value of a display count and an ideal gradient value of the display count of the content selected for distribution to the terminal device by the distribution control code, the increased gradient value of the display count being a gradient value from a start of the distribution until a time point when the display count of the content reaching a predetermined stage before an end of a distribution period, the ideal gradient value of the display count being a gradient value obtained based on a distribution period length and a target display count; and
distribution condition adjusting code configured to cause at least one of said at least one processor to relax or strengthen the distribution condition using a coefficient such that a distribution frequency of the content is varied when an adjustment is determined as necessary from a result of the comparison process by the increasing trend determining code, the coefficient being obtained using the distribution period length and an elapsed period length.

14. The information processing device according to claim 1, wherein
the increasing trend determining code is configured to cause at least one of said at least one processor to execute the comparison process at every elapse of a unit period in a period from the start of the distribution until the end of the distribution of the content, and
the distribution condition adjusting code is configured to cause at least one of said at least one processor to relax or strengthen a fixed width or a fixed count of the distribution condition according to a result of the comparison process.

15. The information processing device according to claim 1, wherein
the distribution condition adjusting code is configured to cause at least one of said at least one processor to relax or strengthen a variable width or a variable count of the distribution condition according to a difference between the increased gradient value and the ideal gradient value obtained as a result of the comparison process.

16. The information processing device according to claim 13, wherein
the distribution condition adjusting code is configured to cause at least one of said at least one processor to relax or strengthen a variable width or a variable count of the distribution condition according to a difference between the increased gradient value and the ideal gradient value obtained as a result of the comparison process.

17. The information processing device according to claim 1, wherein
the increasing trend determining code is configured to cause at least one of said at least one processor to execute the comparison process according to the display count of the content reaching a predetermined stage, and
the distribution condition adjusting code is configured to cause at least one of said at least one processor to relax or strengthen the distribution condition using a coefficient when an adjustment is determined as necessary from a result of the comparison process, the coefficient being obtained using the distribution period length and an elapsed period length.

18. The information processing device according to claim 1, wherein
an appearance ratio indicative of a relative probability of being selected for the distribution between the plurality of pieces of content is set, and
the distribution condition adjusting code is configured to cause at least one of said at least one processor to relax or strengthen the distribution condition by changing the appearance ratio set to the content.

19. The information processing device according to claim 13, wherein
an appearance ratio indicative of a relative probability of being selected for the distribution between the plurality of pieces of content is set, and
the distribution condition adjusting code is configured to cause at least one of said at least one processor to relax or strengthen the distribution condition by changing the appearance ratio set to the content.

20. The information processing device according to claim 1, wherein
the distribution condition adjusting code is configured to cause at least one of said at least one processor to change the distribution condition for another content such that the distribution frequency of the content as a target for the comparison process is varied.

21. The information processing device according to claim 13, wherein
the distribution condition adjusting code is configured to cause at least one of said at least one processor to change the distribution condition for another content such that the distribution frequency of the content as a target for the comparison process is varied.

22. The information processing device according to claim 1, wherein
the distribution control code is configured to cause at least one of said at least one processor to acquire information on the terminal device as the distribution destination, and to select the content for distribution to the terminal device using the acquired terminal information.

23. The information processing device according to claim 13, wherein
the distribution control code is configured to cause at least one of said at least one processor to acquire information on the terminal device as a distribution destination, and to select the content for distribution to the terminal device using the acquired terminal information.

24. The information processing device according to claim 1, wherein
the distribution control unit code is configured to cause at least one of said at least one processor to acquire information on a display size in the terminal device as the distribution destination, and to select the content for distribution to the terminal device using the acquired information on the display size.

25. The information processing device according to claim 13, wherein
the distribution control unit code is configured to cause at least one of said at least one processor to acquire information on a display size in the terminal device as a distribution destination, and to select the content for distribution to the terminal device using the acquired information on the display size.

26. An information processing method executed by an information processing device comprising:
selecting content for distribution to a terminal device in accordance with a distribution condition set to each piece of content, at least a targeting condition indicative of an attribute of a distribution destination being set as the distribution condition to each piece of content;
executing a comparison process between an increased gradient value of a display count and an ideal gradient value of the display count of the content selected for distribution to the terminal device, the increased gradient value of the display count being a gradient value from a start of the distribution until a certain time point before an end of a distribution period, the ideal gradient value of the display count being a gradient value obtained based on a distribution period length and a target display count; and
relaxing or strengthening the distribution condition by increasing or decreasing a count of the attribute of the distribution destination as the targeting condition set to the content such that a distribution frequency of the content is varied according to a comparison result of the comparison process.

27. A non-transitory computer readable storage medium having stored thereon a computer program configured to cause an information processing device to:
select content for distribution to a terminal device in accordance with a distribution condition set to each piece of content, at least a targeting condition indicative of an attribute of a distribution destination being set as the distribution condition to each piece of content;
execute a comparison process between an increased gradient value of a display count and an ideal gradient value of the display count of the content selected for distribution to the terminal device, the increased gradient value of the display count being a gradient value from a start of the distribution until a certain time point before an end of a distribution period, the ideal gradient value of the display count being a gradient value obtained based on a distribution period length and a target display count; and
relax or strengthen the distribution condition by increasing or decreasing a count of the attribute of the distribution destination as the targeting condition set to the content such that a distribution frequency of the content is varied according to a comparison result of the comparison process.

28. An information processing method executed by an information processing device comprising:
selecting content for distribution to a terminal device in accordance with a distribution condition set to each piece of content;
executing a comparison process between an increased gradient value of a display count and an ideal gradient value of the display count of the content selected for distribution to the terminal device, the increased gradient value of the display count being a gradient value from a start of the distribution until a time point when the display count of the content reaching a predetermined stage before an end of a distribution period, the ideal gradient value of the display count being a gradient value obtained based on a distribution period length and a target display count; and
relaxing or strengthening the distribution condition using a coefficient such that a distribution frequency of the content is varied when an adjustment is determined as necessary from a result of the comparison process, the coefficient being obtained using the distribution period length and an elapsed period length.

29. A non-transitory computer readable storage medium having stored thereon a computer program configured to cause an information processing device to:
select content for distribution to a terminal device in accordance with a distribution condition set to each piece of content;
execute a comparison process between an increased gradient value of a display count and an ideal gradient value of the display count of the content selected for distribution to the terminal device, the increased gradient value of the display count being a gradient value from a start of the distribution until a time point when the display count of the content reaching a predetermined stage before an end of a distribution period, the ideal gradient value of the display count being a gradient value obtained based on a distribution period length and a target display count; and
relax or strengthen the distribution condition using a coefficient such that a distribution frequency of the content is varied when an adjustment is determined as necessary from a result of the comparison process, the coefficient being obtained using the distribution period length and an elapsed period length.
